(19) United States
(12) Patent Application Publication
(10) Pub. No.: US 2026/0046866 A1
(43) Pub. Date: Feb. 12, 2026

(54) ENHANCED SCHEDULING REQUEST CONFIGURATIONS

(71) Applicant: QUALCOMM Incorporated, San Diego, CA (US)

(72) Inventor: Linhai HE, San Diego, CA (US)

(21) Appl. No.: 19/289,849

(22) Filed: Aug. 4, 2025

Related U.S. Application Data
(60) Provisional application No. 63/680,769, filed on Aug. 8, 2024.

(51) Int. Cl. H04W 72/1268; H04W 72/232

(52) U.S. Cl. CPC H04W 72/1268; H04W 72/232

(57) ABSTRACT

Various aspects of the present disclosure generally relate to wireless communication. In some aspects, a user equipment (UE) may receive a scheduling request (SR) configuration. The UE may activate the SR configuration in accordance with a trigger event. The UE may transmit an SR in a physical uplink control channel (PUCCH) occasion associated with the SR configuration. The UE may monitor a physical downlink control channel (PDCCH) search space for a PDCCH that carries an uplink grant associated with the SR. Numerous other aspects are described.

### CROSS-REFERENCE TO RELATED APPLICATION

This Patent Application claims priority to U.S. Provisional Ser. No. 63/680,769, filed on Aug. 8, 2024, entitled “ENHANCED SCHEDULING REQUEST CONFIGURATIONS,” and assigned to the assignee hereof. The disclosure of the prior Application is considered part of and is incorporated by reference into this Patent Application.

### INTRODUCTION

Aspects of the present disclosure generally relate to wireless communication and specifically relate to techniques, apparatuses, and methods for scheduling request (SR) configurations.

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

Some aspects described herein relate to an apparatus for wireless communication at user equipment (UE). The apparatus may include one or more memories and one or more processors coupled with the one or more memories. The one or more processors may be configured to cause the UE to receive a scheduling request (SR) configuration. The one or more processors may be configured to cause the UE to activate the SR configuration in accordance with a trigger event. The one or more processors may be configured to cause the UE to transmit an SR in a physical uplink control channel (PUCCH) occasion associated with the SR configuration. The one or more processors may be configured to cause the UE to monitor a physical downlink control channel (PDCCH) search space for a PDCCH that carries an uplink grant associated with the SR.

Some aspects described herein relate to an apparatus for wireless communication at a UE. The apparatus may include one or more memories and one or more processors coupled with the one or more memories. The one or more processors may be configured to cause the UE to receive an SR configuration associated with a single-bit PUCCH format and a multi-bit PUCCH format. The one or more processors may be configured to cause the UE to transmit an SR associated with a PUCCH format selected from the single-bit PUCCH format and the multi-bit PUCCH format. The one or more processors may be configured to cause the UE to monitor a PDCCH search space for a PDCCH that carries an uplink grant associated with the SR.

Some aspects described herein relate to an apparatus for wireless communication at a network node. The apparatus may include one or more memories and one or more processors coupled with the one or more memories. The one or more processors may be configured to cause the network node to send an SR configuration associated with a trigger event for activating the SR configuration. The one or more processors may be configured to cause the network node to obtain an SR in a PUCCH occasion associated with the SR configuration.

Some aspects described herein relate to an apparatus for wireless communication at a network node. The apparatus may include one or more memories and one or more processors coupled with the one or more memories. The one or more processors may be configured to cause the network node to send an SR configuration associated with a single-bit PUCCH format and a multi-bit PUCCH format. The one or more processors may be configured to cause the network node to obtain an SR associated with a PUCCH format selected from the single-bit PUCCH format and the multi-bit PUCCH format.

Some aspects described herein relate to a method of wireless communication performed at a UE. The method may include receiving an SR configuration. The method may include activating the SR configuration in accordance with a trigger event. The method may include transmitting an SR in a PUCCH occasion associated with the SR configuration. The method may include monitoring a PDCCH search space for a PDCCH that carries an uplink grant associated with the SR.

Some aspects described herein relate to a method of wireless communication performed at a UE. The method may include receiving an SR configuration associated with a single-bit PUCCH format and a multi-bit PUCCH format. The method may include transmitting an SR associated with a PUCCH format selected from the single-bit PUCCH format and the multi-bit PUCCH format. The method may include monitoring a PDCCH search space for a PDCCH that carries an uplink grant associated with the SR.

Some aspects described herein relate to a method of wireless communication performed at a network node. The method may include sending an SR configuration associated with a trigger event for activating the SR configuration. The method may include obtaining an SR in a PUCCH occasion associated with the SR configuration.

Some aspects described herein relate to a method of wireless communication performed at a network node. The method may include sending an SR configuration associated with a single-bit PUCCH format and a multi-bit PUCCH format. The method may include obtaining an SR associated with a PUCCH format selected from the single-bit PUCCH format and the multi-bit PUCCH format.

Some aspects described herein relate to a non-transitory computer-readable medium that stores a set of instructions for wireless communication by a UE. The set of instructions, when executed by one or more processors of the UE, may cause the UE to receive an SR configuration. The set of instructions, when executed by one or more processors of the UE, may cause the UE to activate the SR configuration in accordance with a trigger event. The set of instructions, when executed by one or more processors of the UE, may cause the UE to transmit an SR in a PUCCH occasion associated with the SR configuration. The set of instructions, when executed by one or more processors of the UE, may cause the UE to monitor a PDCCH search space for a PDCCH that carries an uplink grant associated with the SR.

Some aspects described herein relate to a non-transitory computer-readable medium that stores a set of instructions for wireless communication by a UE. The set of instructions, when executed by one or more processors of the UE, may cause the UE to receive an SR configuration associated with a single-bit PUCCH format and a multi-bit PUCCH format. The set of instructions, when executed by one or more processors of the UE, may cause the UE to transmit an SR associated with a PUCCH format selected from the single-bit PUCCH format and the multi-bit PUCCH format. The set of instructions, when executed by one or more processors of the UE, may cause the UE to monitor a PDCCH search space for a PDCCH that carries an uplink grant associated with the SR.

Some aspects described herein relate to a non-transitory computer-readable medium that stores a set of instructions for wireless communication by a network node. The set of instructions, when executed by one or more processors of the network node, may cause the network node to send an SR configuration associated with a trigger event for activating the SR configuration. The set of instructions, when executed by one or more processors of the network node, may cause the network node to obtain an SR in a PUCCH occasion associated with the SR configuration.

Some aspects described herein relate to a non-transitory computer-readable medium that stores a set of instructions for wireless communication by a network node. The set of instructions, when executed by one or more processors of the network node, may cause the network node to send an SR configuration associated with a single-bit PUCCH format and a multi-bit PUCCH format. The set of instructions, when executed by one or more processors of the network node, may cause the network node to obtain an SR associated with a PUCCH format selected from the single-bit PUCCH format and the multi-bit PUCCH format.

Some aspects described herein relate to an apparatus for wireless communication. The apparatus may include means for receiving an SR configuration. The apparatus may include means for activating the SR configuration in accordance with a trigger event. The apparatus may include means for transmitting an SR in a PUCCH occasion associated with the SR configuration. The apparatus may include means for monitoring a PDCCH search space for a PDCCH that carries an uplink grant associated with the SR.

Some aspects described herein relate to an apparatus for wireless communication. The apparatus may include means for receiving an SR configuration associated with a single-bit PUCCH format and a multi-bit PUCCH format. The apparatus may include means for transmitting an SR associated with a PUCCH format selected from the single-bit PUCCH format and the multi-bit PUCCH format. The apparatus may include means for monitoring a PDCCH search space for a PDCCH that carries an uplink grant associated with the SR.

Some aspects described herein relate to an apparatus for wireless communication. The apparatus may include means for sending an SR configuration associated with a trigger event for activating the SR configuration. The apparatus may include means for obtaining an SR in a PUCCH occasion associated with the SR configuration.

Some aspects described herein relate to an apparatus for wireless communication. The apparatus may include means for sending an SR configuration associated with a single-bit PUCCH format and a multi-bit PUCCH format. The apparatus may include means for obtaining an SR associated with a PUCCH format selected from the single-bit PUCCH format and the multi-bit PUCCH format.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for that carries out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless network, in accordance with the present disclosure.

FIG. 2 is a diagram illustrating an example network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a discontinuous reception configuration, in accordance with the present disclosure.

FIG. 5 is a diagram illustrating an example architecture of a functional framework for radio access network intelligence enabled by data collection, in accordance with the present disclosure.

FIG. 6 is a diagram illustrating an example of a scheduling request (SR) configuration, in accordance with the present disclosure.

FIG. 7 is a diagram illustrating an example of an enhanced SR configuration, in accordance with the present disclosure.

FIGS. 8-9 are flowcharts illustrating example processes performed, for example, by a UE, in accordance with the present disclosure.

FIGS. 10-11 are flowcharts illustrating example processes performed, for example, by a network node, in accordance with the present disclosure.

FIG. 12 is a diagram of an example apparatus for wireless communication, in accordance with the present disclosure.

FIG. 13 is a diagram illustrating an example of a hardware implementation for an apparatus employing a processing system, in accordance with the present disclosure.

FIG. 14 is a diagram illustrating an example of an implementation of code and circuitry for an apparatus, in accordance with the present disclosure.

FIG. 15 is a diagram of an example apparatus for wireless communication, in accordance with the present disclosure.

FIG. 16 is a diagram illustrating an example of a hardware implementation for an apparatus employing a processing system, in accordance with the present disclosure.

FIG. 17 is a diagram illustrating an example of an implementation of code and circuitry for an apparatus, in accordance with the present disclosure.

### DETAILED DESCRIPTION

In a wireless network, a scheduling request (SR) is a physical layer message that a user equipment (UE) transmits to a network node to request an uplink grant that indicates an uplink resource allocation for the UE to transmit uplink data. For example, the network node may send or otherwise provide an SR configuration to the UE, where the SR configuration may indicate parameters such as an SR identifier (e.g., to enable modification to the SR configuration and/or a mapping to a logical channel (LCH)), a physical uplink control channel (PUCCH) resource associated with PUCCH occasions (or SR occasions) in which the UE can transmit an SR, a periodicity and offset associated with the PUCCH occasions for transmitting an SR, and/or a priority index that indicates whether the SR configuration has a high priority or a low priority for physical layer prioritization and/or multiplexing handling, among other examples. Accordingly, when an SR is triggered (e.g., when new uplink data arrives in an uplink buffer, uplink data in the uplink buffer equals, exceeds, or otherwise satisfies a threshold, or an SR periodicity has elapsed), the UE may transmit an SR to the network node in a PUCCH occasion associated with the SR configuration to request an uplink grant. The network node may then process the SR and allocate uplink resources according to various factors (e.g., resource availability and/or channel conditions), and send a downlink control information (DCI) message that indicates the uplink grant to the UE. The UE may then transmit uplink data in a physical uplink shared channel (PUSCH) transmission, in a PUSCH resource indicated in the uplink grant.

However, SR configurations used in a wireless network can be improved upon in various ways. For example, because the periodicity associated with an SR configuration impacts how quickly a UE can transmit an SR and receive an uplink grant, the UE may need to have more frequent SR resources (e.g., a shorter SR periodicity, resulting in more frequent PUCCH occasions) in order to reduce the time until an uplink grant is available. Accordingly, a shorter SR periodicity may reduce latency associated with delay-sensitive uplink traffic (e.g., extended reality (XR) traffic). However, when a shorter SR periodicity is configured, some PUCCH resources that are allocated may be unused in any PUCCH occasions where the UE does not transmit an SR (e.g., because the UE does not have uplink data to transmit). Accordingly, a network node may be configured to avoid increasing the total amount of PUCCH resources allocated per UE, and to configure a shorter SR periodicity (and thereby enable a shorter latency) only when SR resources are being efficiently used (e.g., the UE is transmitting an SR in most PUCCH occasions associated with an SR configuration). Furthermore, uplink traffic may be classified according to different types (e.g., control traffic or data traffic) or priorities (e.g., delay-sensitive or delay-tolerant) according to LCHs that are mapped to different SR configurations. As a result, SR resources are associated with a hard partition between different SR types or priorities, leading to inefficient PUCCH resource usage. For example, a UE cannot transmit an SR triggered by a first LCH using an SR configuration mapped to a second LCH, even if a next SR occasion associated with the second LCH is available sooner than a next SR occasion associated with the first LCH that triggered the SR. In another example, an SR configuration may be dedicated to beam failure recovery (BFR) requests or other procedures, which leads to PUCCH resources being allocated to procedures that in some cases occur infrequently.

Various aspects relate generally to enhanced SR configurations that may reduce latency associated with a UE obtaining an uplink grant and/or more efficient PUCCH resource usage. For example, some aspects described herein more relate to adaptive SR configurations that can be dynamically activated or deactivated when certain trigger events occur, jointly adapted with a physical downlink control channel (PDCCH) configuration, and/or jointly adapted with a discontinuous reception (DRX) state. For example, in some aspects, a network node may configure one or more candidate SR configurations for a UE (e.g., using radio resource control (RRC) or other semi-persistent or semi-static scheduling), and may use Layer 1 or Layer 2 (L1/L2) signaling to dynamically activate or deactivate one or more of the candidate SR configurations that are configured for the UE. Furthermore, in some aspects, an SR configuration may be mapped to a PDCCH search space (e.g., such that SR configurations and PDCCH search spaces may have similar periodicities), and the UE may autonomously activate or deactivate one or more SR configurations according to a monitored PDCCH search space. Additionally, or alternatively, the network node may designate one candidate SR configuration as a default SR configuration to be used when the UE and the network node are in an unsynchronized state. Furthermore, in order to conserve power during a DRX inactive time and enable lower latency, a UE may deactivate SR resources associated with a high priority when entering the DRX inactive time and may activate SR resources associated with a high priority when a DRX on duration is starting and/or a wakeup signal is received during the DRX inactive time.

Furthermore, in addition to enabling adaptive SR configurations that can be dynamically activated or deactivated and/or associated with other configurations, a UE may use artificial intelligence or machine learning (AI/ML) techniques or other suitable techniques to predict when uplink data will arrive in an uplink buffer. For example, when the UE obtains a prediction that new data will arrive in the uplink buffer (e.g., using local predictive capabilities or predictive capabilities associated with another device or entity) and SR resources are not configured or otherwise not immediately available, a predictive buffer status report (BSR) or a predictive SR may be triggered to request high-priority SR resources before the new uplink data arrives in the uplink buffer, and thereby reduce latency. Furthermore, in some aspects, the network node may configure one or more conditions to avoid the UE transmitting excessive predictive BSRs and/or predictive SRs (e.g., a UE may be permitted to transmit a predictive BSR and/or a predictive SR only when high-priority resources are unavailable, the new uplink data is predicted to arrive in a configured time window, and/or the UE has not transmitted another predictive BSR or predictive SR within a threshold time period).

Furthermore, some aspects described herein relate to an SR configuration that may be associated with mixed PUCCH formats, such as a single-bit PUCCH format and/or a multi-bit PUCCH format, which may enable the SR configuration to be used for all SR types and/or priorities. For example, in some aspects, an SR may be transmitted using a multi-bit PUCCH format to indicate a priority associated with the SR and/or a trigger associated with the SR (e.g., to trigger BFR for a transmission reception point (TRP) or a secondary cell (Scell), to activate or deactivate a measurement gap, or the like). In some aspects, the single-bit PUCCH format may be dedicated to high-priority SRs (e.g., such that an SR transmitted using the single-bit PUCCH format implicitly indicates a high priority), and high-priority SRs may use PUCCH occasions associated with the single-bit PUCCH format or the multi-bit PUCCH format to reduce a latency associated with the high-priority SRs. For example, in some aspects, the network node may configure a start offset and a periodicity for PUCCH occasions associated with the single-bit PUCCH format and PUCCH occasions associated with the multi-bit PUCCH format, and the multi-bit PUCCH format may be used in any multi-bit PUCCH occasions that overlap with a single-bit PUCCH occasion. In this way, associating an SR configuration with different PUCCH formats can avoid a hard partition between SR configurations, which may lead to more efficient PUCCH resource usage. Furthermore, because PUCCH occasions with the single-bit PUCCH format are reserved to high-priority SRs, the single-bit PUCCH occasions can be dynamically activated or deactivated (e.g., used only when needed), which may lead to increased efficiency because more SR resources can be allocated to reduce scheduling latency for delay-sensitive uplink traffic, and the SR resources may be deallocated when there is no delay-sensitive uplink traffic or a small amount of delay-sensitive uplink traffic.

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, XR and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

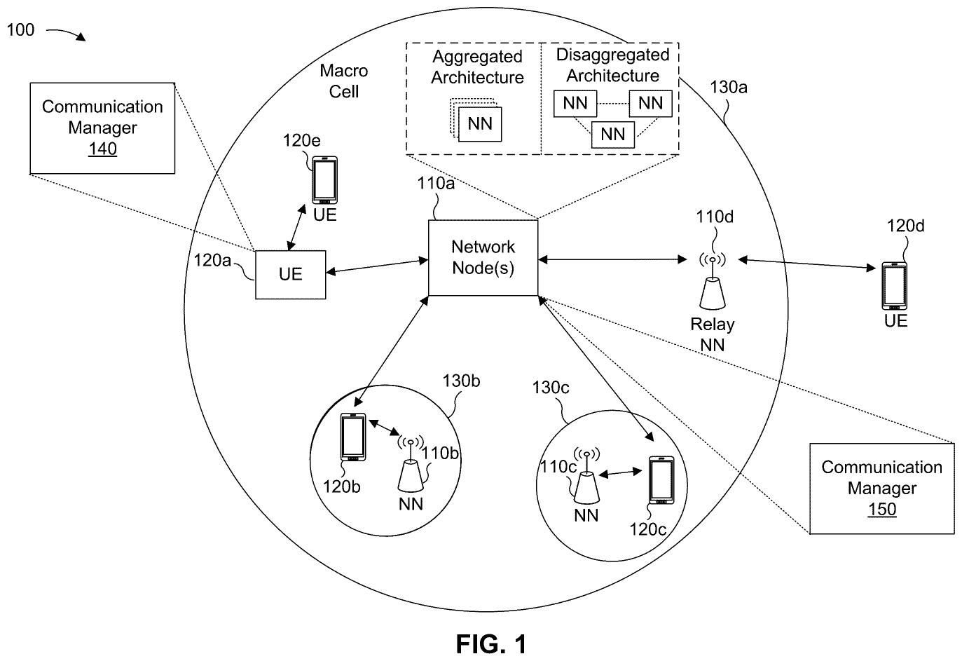

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120e.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/Long Term Evolution (LTE) and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a TRP, a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or a NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit DCI (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more PDCCHs, and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more PUCCHs, and uplink data channels may include one or more PUSCHs. The downlink and the uplink may each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). A processor also may be implemented as a combination of computing devices, for example, a combination of a DSP and a microprocessor, a plurality of microprocessors, one or more microprocessors in conjunction with a DSP core, or any other such configuration. One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, Institute of Electrical and Electronics Engineers (IEEE) compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

Some UEs 120 may be considered machine-type communication (MTC) UEs, evolved or enhanced machine-type communication (eMTC), UEs, further enhanced eMTC (feMTC) UEs, or enhanced feMTC (efeMTC) UEs, or further evolutions thereof, all of which may be simply referred to as “MTC UEs”. An MTC UE may be, may include, or may be included in or coupled with a robot, an uncrewed aerial vehicle, a remote device, a sensor, a meter, a monitor, and/or a location tag. Some UEs 120 may be considered IoT devices and/or may be implemented as NB-IoT (narrowband IoT) devices. An IoT UE or NB-IoT device may be, may include, or may be included in or coupled with an industrial machine, an appliance, a refrigerator, a doorbell camera device, a home automation device, and/or a light fixture, among other examples. Some UEs 120 may be considered Customer Premises Equipment, which may include telecommunications devices that are installed at a customer location (such as a home or office) to enable access to a service provider's network (such as included in or in communication with the wireless communication network 100).

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between UEs 120 of the first category and UEs 120 of the second capability). A UE 120 of the third category may be referred to as a reduced capacity UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, and/or cameras that are associated with a limited bandwidth, power capacity, and/or transmission range, among other examples. RedCap UEs may support healthcare environments, building automation, electrical distribution, process automation, transport and logistics, and/or smart city deployments, among other examples.

In some examples, two or more UEs 120 (for example, shown as UE 120a and UE 120e) may communicate directly with one another using sidelink communications (for example, without communicating by way of a network node 110 as an intermediary). As an example, the UE 120a may directly transmit data, control information, or other signaling as a sidelink communication to the UE 120e. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In various examples, some of the network nodes 110 and the UEs 120 of the wireless communication network 100 may be configured for full-duplex operation in addition to half-duplex operation. A network node 110 or a UE 120 operating in a half-duplex mode may perform only one of transmission or reception during particular time resources, such as during particular slots, symbols, or other time periods. Half-duplex operation may involve time-division duplexing (TDD), in which DL transmissions of the network node 110 and UL transmissions of the UE 120 do not occur in the same time resources (that is, the transmissions do not overlap in time). In contrast, a network node 110 or a UE 120 operating in a full-duplex mode can transmit and receive communications concurrently (for example, in the same time resources). By operating in a full-duplex mode, network nodes 110 and/or UEs 120 may generally increase the capacity of the network and the radio access link. In some examples, full-duplex operation may involve frequency-division duplexing (FDD), in which DL transmissions of the network node 110 are performed in a first frequency band or on a first component carrier and transmissions of the UE 120 are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an UL transmission to a first network node 110 and receive a DL transmission from a second network node 110 in the same time resources. In some other examples, full-duplex operation may be enabled for a network node 110 but not for a UE 120. For example, a network node 110 may simultaneously transmit a DL transmission to a first UE 120 and receive an UL transmission from a second UE 120 in the same time resources. In some other examples, full-duplex operation may be enabled for both a network node 110 and a UE 120.

In some examples, the UEs 120 and the network nodes 110 may perform MIMO communication. “MIMO” generally refers to transmitting or receiving multiple signals (such as multiple layers or multiple data streams) simultaneously over the same time and frequency resources. MIMO techniques generally exploit multipath propagation. MIMO may be implemented using various spatial processing or spatial multiplexing operations. In some examples, MIMO may support simultaneous transmission to multiple receivers, referred to as multi-user MIMO (MU-MIMO). Some RATs may employ advanced MIMO techniques, such as mTRP operation (including redundant transmission or reception on multiple TRPs), reciprocity in the time domain or the frequency domain, single-frequency-network (SFN) transmission, or non-coherent joint transmission (NC-JT).

In some aspects, the UE 120 may include a communication manager 140. As described in more detail elsewhere herein, the communication manager 140 may receive an SR configuration; activate the SR configuration in accordance with a trigger event; transmit an SR in a PUCCH occasion associated with the SR configuration; and monitor a PDCCH search space for a PDCCH that carries an uplink grant associated with the SR. Additionally, or alternatively, the communication manager 140 may receive an SR configuration associated with a single-bit PUCCH format and a multi-bit PUCCH format; transmit an SR associated with a PUCCH format selected from the single-bit PUCCH format and the multi-bit PUCCH format; and monitor a PDCCH search space for a PDCCH that carries an uplink grant associated with the SR. Additionally, or alternatively, the communication manager 140 may perform one or more other operations described herein.

In some aspects, the network node 110 may include a communication manager 150. As described in more detail elsewhere herein, the communication manager 150 may send an SR configuration associated with a trigger event for activating the SR configuration; and obtain an SR in a PUCCH occasion associated with the SR configuration. Additionally, or alternatively, the communication manager 150 may send an SR configuration associated with a single-bit PUCCH format and a multi-bit PUCCH format; and obtain an SR associated with a PUCCH format selected from the single-bit PUCCH format and the multi-bit PUCCH format. Additionally, or alternatively, the communication manager 150 may perform one or more other operations described herein.

As indicated above, FIG. 1 is provided as an example. Other examples may differ from what is described with regard to FIG. 1.

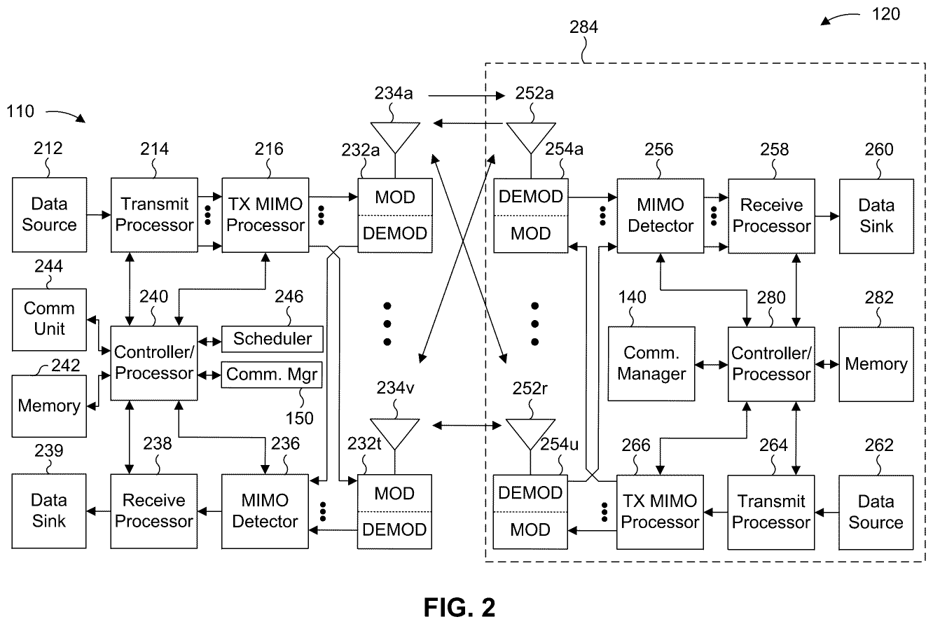

FIG. 2 is a diagram illustrating an example network node 110 in communication with an example UE 120 in a wireless network, in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes may be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (RX) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

In some examples, each of the antenna elements of an antenna 234 or an antenna 252 may include one or more sub-elements for radiating or receiving radio frequency signals. For example, a single antenna element may include a first sub-element cross-polarized with a second sub-element that can be used to independently transmit cross-polarized signals. The antenna elements may include patch antennas, dipole antennas, and/or other types of antennas arranged in a linear pattern, a two-dimensional pattern, or another pattern. A spacing between antenna elements may be such that signals with a desired wavelength transmitted separately by the antenna elements may interact or interfere constructively and destructively along various directions (such as to form a desired beam). For example, given an expected range of wavelengths or frequencies, the spacing may provide a quarter wavelength, a half wavelength, or another fraction of a wavelength of spacing between neighboring antenna elements to allow for the desired constructive and destructive interference patterns of signals transmitted by the separate antenna elements within that expected range.

The amplitudes and/or phases of signals transmitted via antenna elements and/or sub-elements may be modulated and shifted relative to each other (such as by manipulating phase shift, phase offset, and/or amplitude) to generate one or more beams, which is referred to as beamforming. The term “beam” may refer to a directional transmission of a wireless signal toward a receiving device or otherwise in a desired direction. “Beam” may also generally refer to a direction associated with such a directional signal transmission, a set of directional resources associated with the signal transmission (for example, an angle of arrival, a horizontal direction, and/or a vertical direction), and/or a set of parameters that indicate one or more aspects of a directional signal, a direction associated with the signal, and/or a set of directional resources associated with the signal. In some implementations, antenna elements may be individually selected or deselected for directional transmission of a signal (or signals) by controlling amplitudes of one or more corresponding amplifiers and/or phases of the signal(s) to form one or more beams. The shape of a beam (such as the amplitude, width, and/or presence of side lobes) and/or the direction of a beam (such as an angle of the beam relative to a surface of an antenna array) can be dynamically controlled by modifying the phase shifts, phase offsets, and/or amplitudes of the multiple signals relative to each other.

Different UEs 120 or network nodes 110 may include different numbers of antenna elements. For example, a UE 120 may include a single antenna element, two antenna elements, four antenna elements, eight antenna elements, or a different number of antenna elements. As another example, a network node 110 may include eight antenna elements, 24 antenna elements, 64 antenna elements, 128 antenna elements, or a different number of antenna elements. Generally, a larger number of antenna elements may provide increased control over parameters for beam generation relative to a smaller number of antenna elements, whereas a smaller number of antenna elements may be less complex to implement and may use less power than a larger number of antenna elements. Multiple antenna elements may support multiple-layer transmission, in which a first layer of a communication (which may include a first data stream) and a second layer of a communication (which may include a second data stream) are transmitted using the same time and frequency resources with spatial multiplexing.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

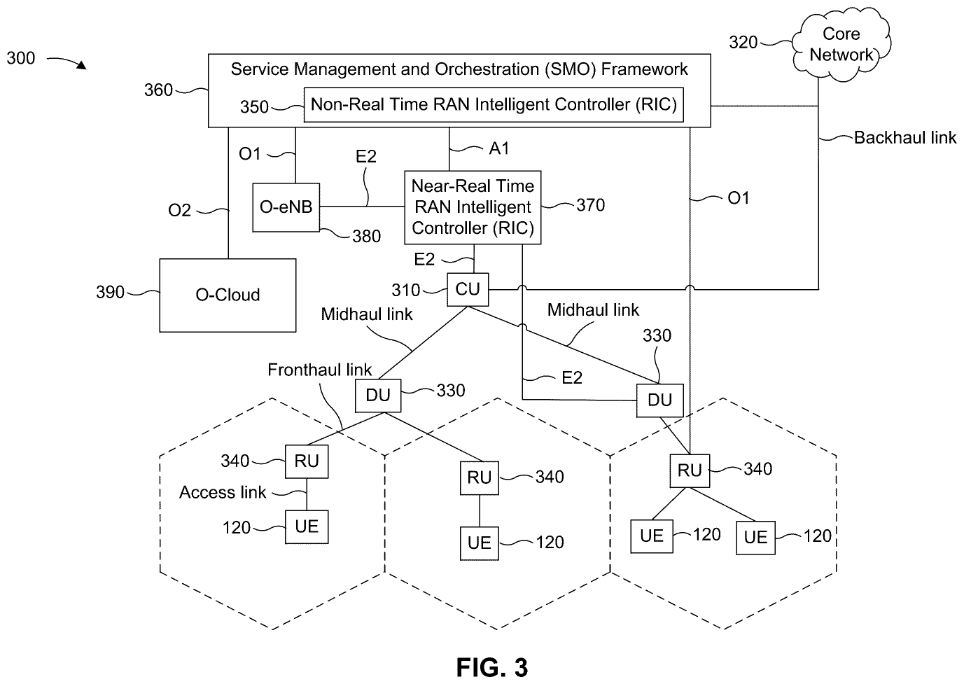

FIG. 3 is a diagram illustrating an example disaggregated base station architecture 300, in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-eNB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, artificial intelligence and/or machine learning (AI/ML) workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

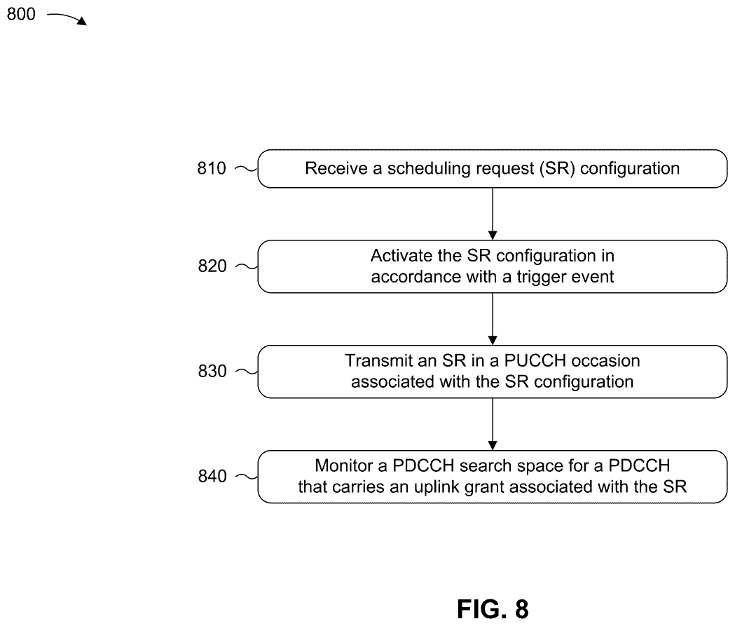

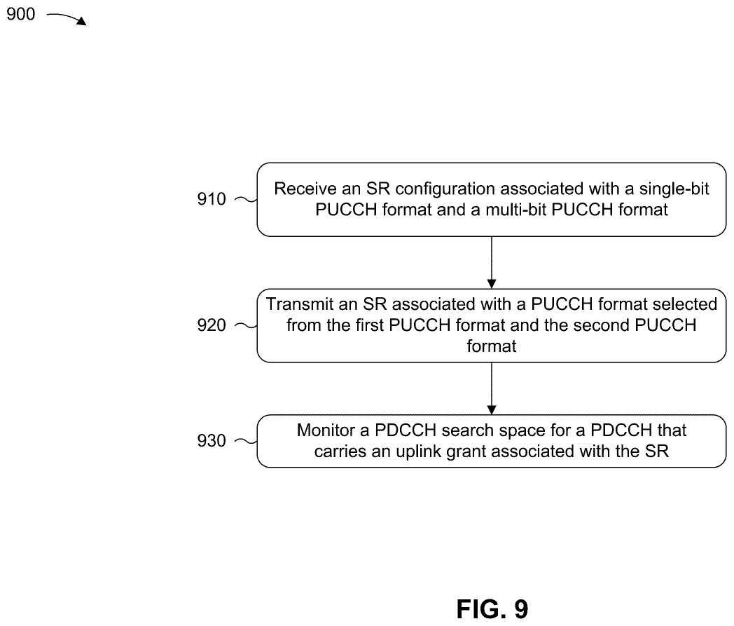

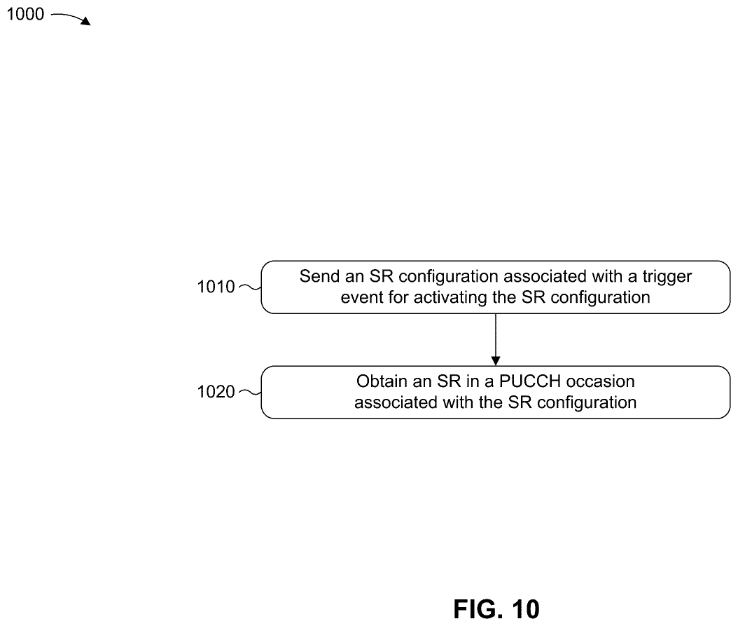

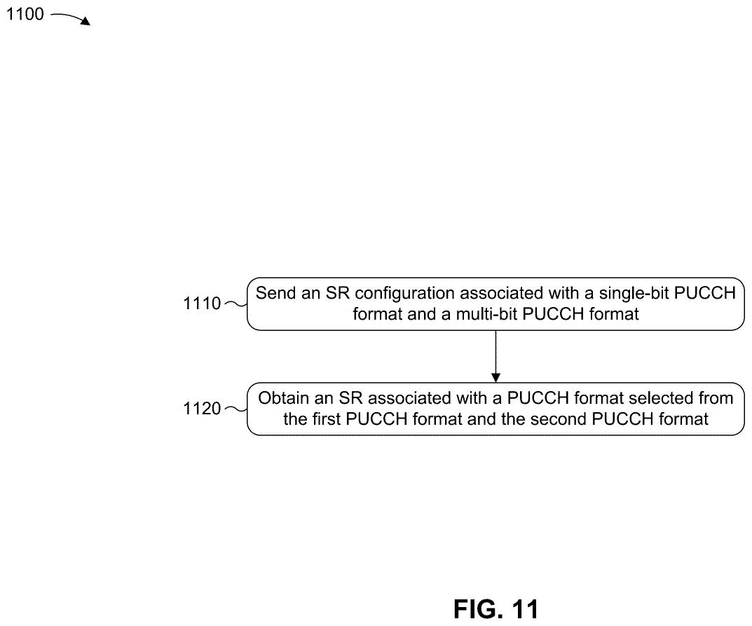

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with enhanced SR configurations, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 800 of FIG. 8, process 900 of FIG. 9, process 1000 of FIG. 10, process 1100 of FIG. 11, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 800 of FIG. 8, process 900 of FIG. 9, process 1000 of FIG. 10, process 1100 of FIG. 11, or other processes as described herein. In some examples, executing instructions may include running the instructions, converting the instructions, compiling the instructions, and/or interpreting the instructions, among other examples.

In some aspects, the UE 120 includes means for receiving an SR configuration; means for activating the SR configuration in accordance with a trigger event; means for transmitting an SR in a PUCCH occasion associated with the SR configuration; and/or means for monitoring a PDCCH search space for a PDCCH that carries an uplink grant associated with the SR. Additionally, or alternatively, the UE 120 includes means for receiving an SR configuration associated with a single-bit PUCCH format and a multi-bit PUCCH format; means for transmitting an SR associated with a PUCCH format selected from the single-bit PUCCH format and the multi-bit PUCCH format; and/or means for monitoring a PDCCH search space for a PDCCH that carries an uplink grant associated with the SR. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for sending an SR configuration associated with a trigger event for activating the SR configuration; and/or means for obtaining an SR in a PUCCH occasion associated with the SR configuration. Additionally, or alternatively, the network node 110 includes means for sending an SR configuration associated with a single-bit PUCCH format and a multi-bit PUCCH format; and/or means for obtaining an SR associated with a PUCCH format selected from the single-bit PUCCH format and the multi-bit PUCCH format. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

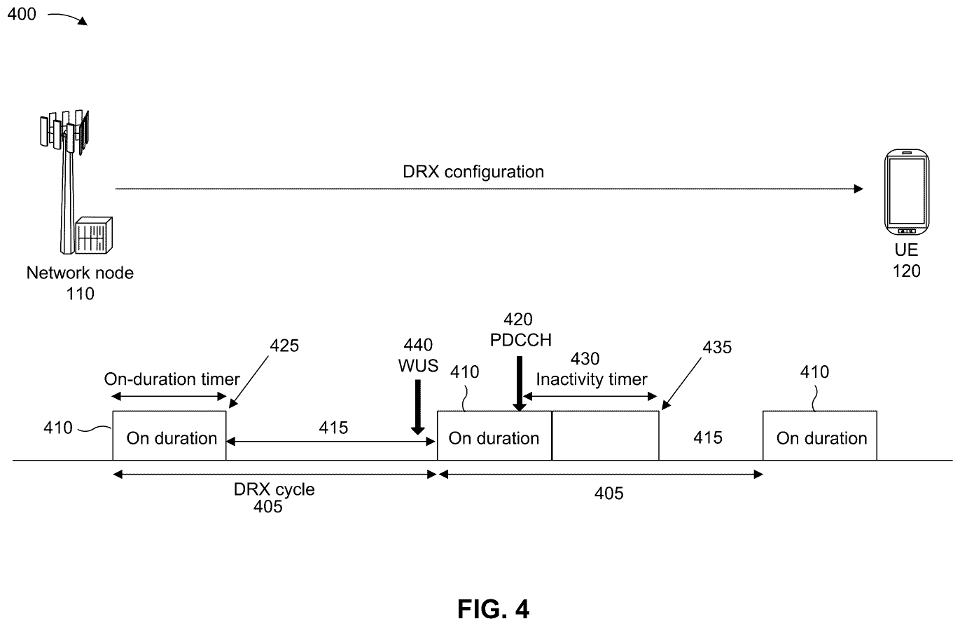

FIG. 4 is a diagram illustrating an example 400 of a DRX configuration, in accordance with the present disclosure.

As shown in FIG. 4, a network node 110 may transmit a DRX configuration to a UE 120 to configure a DRX cycle 405 for the UE 120. A DRX cycle 405 may include a DRX on duration 410 (e.g., during which a UE 120 is awake or in an active state) and an opportunity to enter a DRX sleep state 415. As described herein, the time during which the UE 120 is configured to be in an active state during the DRX on duration 410 may be referred to as an active time, and the time during which the UE 120 is configured to be in the DRX sleep state 415 may be referred to as an inactive time. As described below, the UE 120 may monitor a PDCCH during the active time, and may refrain from monitoring the PDCCH during the inactive time. In addition, the UE 120 may transition to the active state in cases where a wakeup signal (WUS) 440 is received during the inactive time.

During the DRX on duration 410 (e.g., the active time), the UE 120 may monitor a downlink control channel (e.g., a PDCCH), as shown by reference number 420. For example, the UE 120 may monitor the PDCCH for DCI pertaining to the UE 120. If the UE 120 does not detect and/or successfully decode any PDCCH communications intended for the UE 120 during the DRX on duration 410, then the UE 120 may enter the sleep state 415 (e.g., for the inactive time) at the end of the DRX on duration 410, as shown by reference number 425. In this way, the UE 120 may conserve battery power and reduce power consumption. As shown, the DRX cycle 405 may repeat with a configured periodicity according to the DRX configuration.

If the UE 120 detects and/or successfully decodes a PDCCH communication intended for the UE 120, then the UE 120 may remain in an active state (e.g., awake) for the duration of a DRX inactivity timer 430 (e.g., which may extend the active time). The UE 120 may start the DRX inactivity timer 430 at a time at which the PDCCH communication is received (e.g., in a transmission time interval (TTI) in which the PDCCH communication is received, such as a slot or a subframe). The UE 120 may remain in the active state until the DRX inactivity timer 430 expires, at which time the UE 120 may enter the sleep state 415 (e.g., for the inactive time), as shown by reference number 435. During the duration of the DRX inactivity timer 430, the UE 120 may continue to monitor for PDCCH communications, may obtain a downlink data communication (e.g., on a downlink data channel, such as a PDSCH) scheduled by the PDCCH communication, and/or may prepare and/or transmit an uplink communication (e.g., on a PUSCH) scheduled by the PDCCH communication. The UE 120 may restart the DRX inactivity timer 430 after each detection of a PDCCH communication for the UE 120 for an initial transmission (e.g., but not for a retransmission). By operating in this manner, the UE 120 may conserve battery power and reduce power consumption by entering the sleep state 415.

As indicated above, FIG. 4 is provided as an example. Other examples may differ from what is described with respect to FIG. 4.

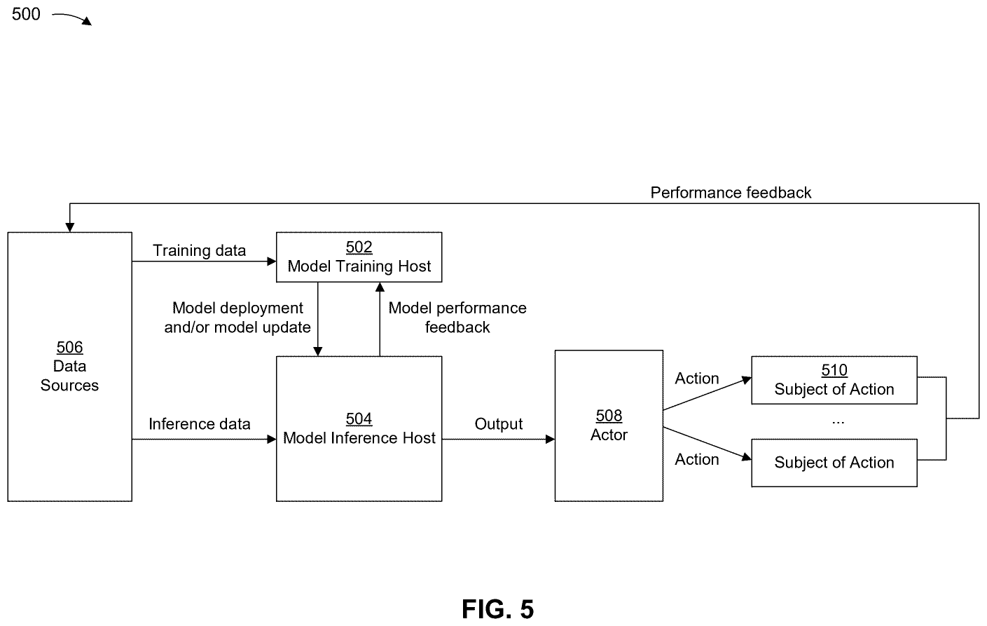

FIG. 5 is a diagram illustrating an example architecture 500 of a functional framework for RAN intelligence enabled by data collection, in accordance with the present disclosure. In some scenarios, the functional framework for RAN intelligence may be enabled by further enhancement of data collection through use cases and/or examples. For example, principles or algorithms for RAN intelligence enabled by AI/ML and the associated functional framework (e.g., the AI functionality and/or the input/output of the component for AI enabled optimization) have been utilized or studied to identify the benefits of AI enabled RAN through possible use cases (e.g., beam management, energy saving, load balancing, mobility management, and/or coverage optimization, among other examples). In one example, as shown by the architecture 500, a functional framework for RAN intelligence may include multiple logical entities, such as a model training host 502, a model inference host 504, data sources 506, and an actor 508.

The model inference host 504 may be configured to run an AI/ML model based on inference data provided by the data sources 506, and the model inference host 504 may produce an output (e.g., a prediction) with the inference data input to the actor 508. The actor 508 may be an element or an entity of a core network or a RAN. For example, the actor 508 may be a UE, a network node, base station (e.g., a gNB), a CU, a DU, and/or an RU, among other examples. In addition, the actor 508 may also depend on the type of tasks performed by the model inference host 504, type of inference data provided to the model inference host 504, and/or type of output produced by the model inference host 504. For example, if the output from the model inference host 504 is associated with position determination, the actor 508 may be a UE, a DU or an RU. In some examples, the model inference host 504 may be hosted on the actor 508. For example, a UE may be the actor 508 and may host the model inference host 504. In some aspects, a UE (e.g., the actor 508) may be a data source 506. For example, the UE may perform a measurement (e.g., an NR measurement), may input the measurement to the AI/ML model at the model inference host 504 (or may provide the measurement to the model inference host 504), and may act based on an output of the AI/ML model (e.g., may trigger a predictive buffer status report or a predictive SR in accordance with a prediction that uplink data will arrive in an uplink buffer).

After the actor 508 receives an output from the model inference host 504, the actor 508 may determine whether to act based on the output. For example, if the actor 508 is a UE and the output from the model inference host 504 is associated with position information, the actor 508 may determine whether to report the position information, reconfigure a beam, among other examples. If the actor 508 determines to act based on the output, in some examples, the actor 508 may indicate the action to at least one subject of action 510.

The data sources 506 may also be configured for collecting data that is used as training data for training an ML model or as inference data for feeding an ML model inference operation. For example, the data sources 506 may collect data from one or more core network and/or RAN entities, which may include the actor 508 or the subject of action 510, and provide the collected data to the model training host 502 for ML model training. In some aspects, the model training host 502 may be co-located with the model inference host 504 and/or the actor 508. For example, the actor 508 or the subject of action 510 may provide performance feedback associated with the beam configuration to the data sources 506, where the performance feedback may be used by the model training host 502 for monitoring or evaluating the ML model performance, such as whether the output (e.g., prediction) provided to the actor 508 is accurate. In some examples, the model training host 502 may monitor or evaluate ML model performance using a training position value, which may be provided by a node (e.g., a UE 120 or a network node 110), as described elsewhere herein. In some examples, if the output provided by the actor 508 is inaccurate (or the accuracy is below an accuracy threshold), then the model training host 502 may determine to modify or retrain the ML model used by the model inference host, such as via an ML model deployment/update.

As indicated above, FIG. 5 is provided as an example. Other examples may differ from what is described with regard to FIG. 5.

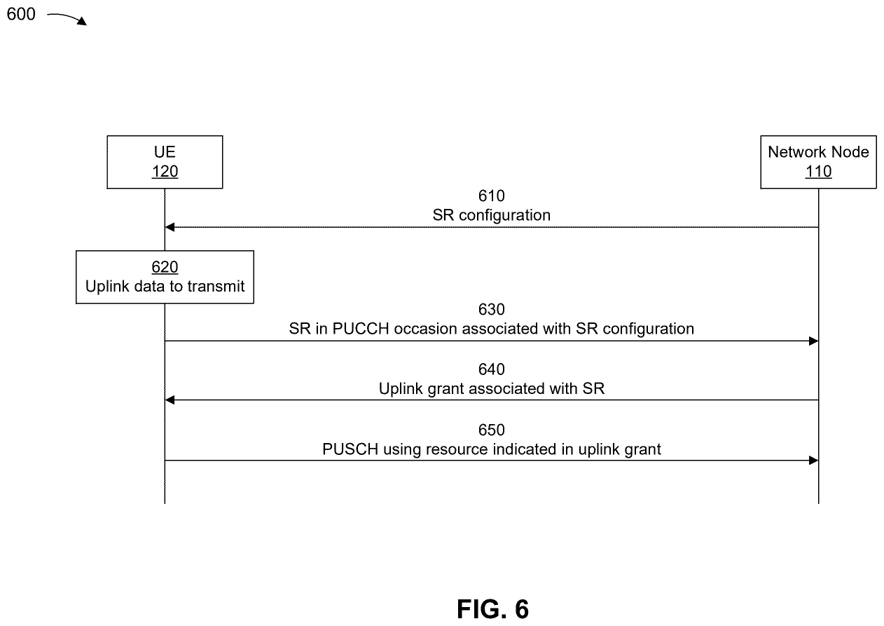

FIG. 6 is a diagram illustrating an example 600 of an SR configuration, in accordance with the present disclosure. As shown in FIG. 6, example 600 includes a network node 110 and a UE 120 that may communicate in a wireless network, such as wireless network 100. The network node 110 and the UE 120 may communicate via a wireless access link, which may include an uplink and a downlink.

As described herein, an SR is a physical layer message that the UE 120 may transmit to the network node 110 to request an uplink grant that indicates an uplink resource allocation for the UE 120 to transmit uplink data. For example, as shown by reference number 610, the network node 110 may send or otherwise provide an SR configuration to the UE 120, where the SR configuration may indicate parameters such as an SR identifier (e.g., to enable modification to the SR configuration and/or a mapping to an LCH), an identifier for a PUCCH resource associated with PUCCH occasions (or SR occasions) in which the UE 120 can transmit an SR, a periodicity and offset associated with the PUCCH occasions for transmitting an SR (e.g., indicated according to a number of symbols, slots, or other TTIs), and/or a priority index that indicates a priority associated with the SR configuration for physical layer prioritization and/or multiplexing handling, among other examples. Furthermore, the SR configuration may indicate one or more parameters that constrain or restrict whether an SR can be transmitted. For example, the SR configuration may indicate a prohibit timer (e.g., a number of milliseconds) that starts when an SR is transmitted and/or may indicate a parameter limiting SR transmissions to a maximum number, such that the UE 120 cannot transmit an SR when the prohibit timer has not expired and/or the maximum number of SR transmissions has been exceeded.

Accordingly, as shown by reference number 620, an SR may be triggered when the UE 120 has uplink data to transmit (e.g., new uplink data arrives in the uplink buffer). Additionally, or alternatively, the SR may be triggered when the buffered uplink data equals, exceeds, or otherwise satisfies a threshold, or an SR periodicity has elapsed. In such cases, as shown by reference number 630, the UE 120 may transmit, and the network node 110 may receive or otherwise obtain, an SR in a PUCCH occasion associated with the SR configuration. As described herein, the UE 120 may transmit the SR in order to request an uplink grant that indicates a PUSCH resource allocation when the SR is triggered and any restrictions or constraints on SR transmission are satisfied. For example, when the SR is triggered, the UE 120 may transmit the SR in a next available PUCCH occasion associated with an LCH, a traffic type, a traffic priority, a procedure, or other suitable configuration mapped to the SR configuration unless the UE 120 has already received an uplink grant, the next available PUCCH occasion falls within a measurement gap, the SR prohibit timer is running, the number of SR transmissions equals or exceeds the maximum number of SR transmissions, and/or the next PUCCH occasion overlaps with PUSCH resources, among other examples.

As further shown by reference number 640, the network node 110 may then process the SR and allocate uplink resources according to various factors (e.g., resource availability, channel conditions, and/or quality of service (QoS) requirements, among other examples), and may send or otherwise provide a DCI message that indicates the uplink grant to the UE 120. As shown by reference number 650, the UE 120 may then transmit the uplink data in a PUSCH (e.g., via a PUSCH resource indicated in the uplink grant).

However, SR configurations that are typically used in a wireless network have various shortcomings and/or limitations. For example, because the periodicity associated with an SR configuration generally defines how quickly the UE 120 can transmit an SR and receive an uplink grant, the UE 120 may need to have more frequent SR resources (e.g., a shorter SR periodicity resulting in more frequent PUCCH occasions) in order to reduce the time until an uplink grant is available, which may be important to reduce latency associated with delay-sensitive uplink traffic (e.g., XR traffic). However, configuring a shorter SR periodicity may lead to inefficient PUCCH resource utilization, because PUCCH resources would be wasted in any PUCCH occasions where the UE 120 does not transmit an SR. Accordingly, the network node 110 may generally avoid increasing the PUCCH resources allocated to the UE 120, and may configure a shorter SR periodicity (and thereby reduce latency) only when SR resources are being efficiently used (e.g., the UE 120 is transmitting an SR in most PUCCH occasions associated with an SR configuration). Furthermore, uplink traffic is typically classified according to different types (e.g., control traffic or data traffic) or priorities (e.g., delay-sensitive or delay-tolerant) according to LCHs that are mapped to different SR configurations. For example, LCHs carry user data and signaling messages between an RLC layer and a MAC layer, in contrast to transport channels that carry user data and signaling messages between the MAC layer and the PHY layer, and physical channels that carry user data and signaling messages between the UE 120 and the network node 110. For example, in an uplink direction, uplink LCHs include a common control channel (CCCH) used to carry control information for multiple UEs 120, a dedicated control channel (DCCH) dedicated to carrying control information for a particular UE 120, and a dedicated traffic channel (DTCH) dedicated to carrying traffic for a particular UE 120. Accordingly, in the uplink direction, the MAC layer performs an LCH prioritization procedure to control the manner in which uplink shared channel (UL-SCH) resources are shared among different LCHs. As a result, SR resources are associated with a hard partition between different SR types or priorities, leading to inefficient PUCCH resource usage. For example, the UE 120 cannot transmit an SR triggered by a first LCH using an SR configuration mapped to a second LCH, even if a next SR occasion associated with the second LCH is available sooner than a next SR occasion associated with the first LCH that triggered the SR. In another example, an SR configuration may be dedicated to BFR requests or other procedures, which leads to PUCCH resources being allocated to procedures that in some cases occur infrequently.

Various aspects relate generally to enhanced SR configurations that may reduce latency associated with a UE 120 obtaining an uplink grant and/or more efficient PUCCH resource usage. For example, some aspects described herein more specifically relate to adaptive SR configurations that can be dynamically activated or deactivated when certain trigger events occur, jointly adapted with a PDCCH configuration, and/or jointly adapted with a DRX state. For example, in some aspects, a network node 110 may configure one or more candidate SR configurations for a UE 120 (e.g., using RRC or other semi-persistent or semi-static scheduling), and may use L1/L2 signaling to dynamically activate or deactivate one or more of the candidate SR configurations configured for the UE 120. Furthermore, in some aspects, an SR configuration may be mapped to a PDCCH search space (e.g., such that SR configurations and PDCCH search spaces may have similar periodicities), and the UE 120 may autonomously activate or deactivate one or more SR configurations according to a monitored PDCCH search space. Additionally, or alternatively, the network node 110 may designate one candidate SR configuration as a default SR configuration to be used when the UE 120 and the network node 110 are in an unsynchronized state. Furthermore, in order to conserve power during a DRX inactive time and enable lower latency, a UE 120 may deactivate SR resources associated with a high priority when entering the DRX inactive time, and may activate SR resources associated with a high priority when a DRX on duration is starting and/or a wakeup signal is received during the DRX inactive time.

Furthermore, in addition to enabling adaptive SR configurations that can be dynamically activated and deactivated and/or associated with other configurations, a UE 120 may use AI/ML techniques or other suitable techniques to predict when uplink data will arrive in an uplink buffer and request SR resources accordingly. For example, when the UE 120 obtains a prediction that new data will arrive in the uplink buffer (e.g., using local predictive capabilities or predictive capabilities associated with another device or entity) and SR resources are not configured or otherwise not immediately available, a predictive BSR or a predictive SR may be triggered to request high-priority SR resources before the new uplink data arrives in the uplink buffer and thereby reduce latency. Furthermore, in some aspects, the network node 110 may configure one or more conditions to avoid the UE 120 transmitting excessive predictive BSRs and/or predictive SRs (e.g., a UE 120 may be permitted to transmit a predictive BSR and/or a predictive SR only when high-priority resources are unavailable, the new uplink data is predicted to arrive in a configured time window, and/or the UE 120 has not transmitted another predictive BSR or predictive SR within a threshold time period).

Furthermore, some aspects described herein relate to an SR configuration that may be associated with mixed PUCCH formats, such as a single-bit PUCCH format and a multi-bit PUCCH format, which may enable the SR configuration to be used for all SR types and/or priorities. For example, in some aspects, an SR may be transmitted using a multi-bit PUCCH format to indicate a priority associated with the SR and/or a trigger, a cause, a reason, an event, or other suitable information associated with the SR (e.g., to initiate BFR for a TRP or an Scell, to activate or deactivate a measurement gap, to indicate an uplink buffer size, or the like). In some aspects, the single-bit PUCCH format may be dedicated to high-priority SRs (e.g., such that an SR transmitted using the single-bit PUCCH format implicitly indicates a high priority), and high-priority SRs may use PUCCH occasions associated with the single-bit PUCCH format or the multi-bit PUCCH format to reduce a latency associated with the high-priority SRs. For example, in some aspects, the network node may configure a start offset and a periodicity for PUCCH occasions associated with the single-bit PUCCH format and PUCCH occasions associated with the multi-bit PUCCH format, and the multi-bit PUCCH format may be used in any multi-bit PUCCH occasions that overlap with a single-bit PUCCH occasion. In this way, associating an SR configuration with different PUCCH formats can avoid a hard partition between SR configurations, which may lead to more efficient PUCCH resource usage. Furthermore, because PUCCH occasions with the single-bit PUCCH format are reserved to high-priority SRs, the single-bit PUCCH occasions can be dynamically activated or deactivated (e.g., used only when needed), which may lead to increased efficiency because more SR resources can be allocated to reduce scheduling latency for delay-sensitive uplink traffic, and the SR resources may be deallocated when there is no delay-sensitive uplink traffic or a small amount of delay-sensitive uplink traffic.

As indicated above, FIG. 6 is provided as an example. Other examples may differ from what is described with regard to FIG. 6.

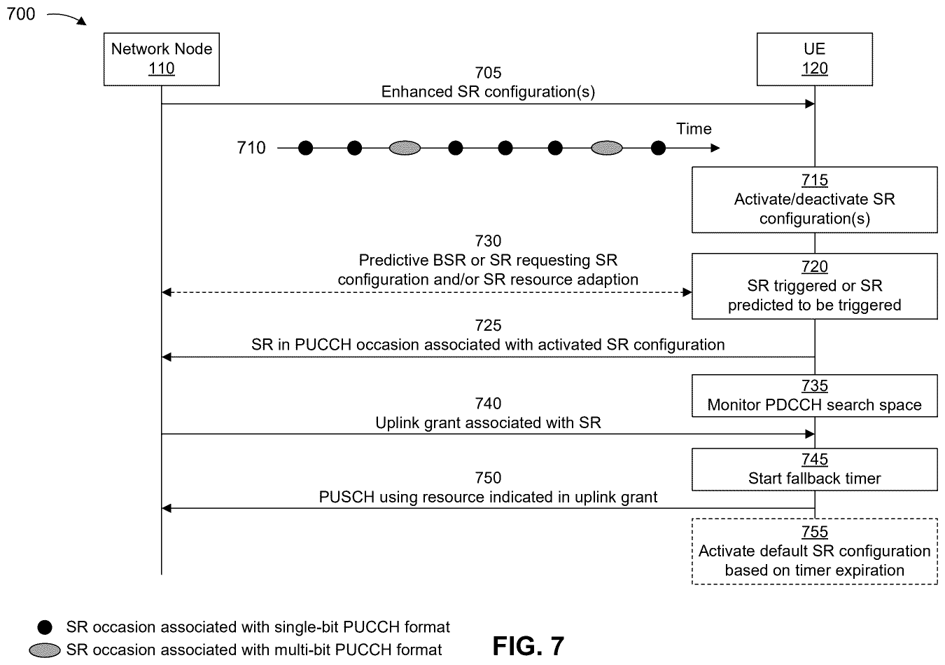

FIG. 7 is a diagram illustrating an example of an enhanced SR configuration, in accordance with the present disclosure. As shown in FIG. 7, example 700 includes a network node 110 and a UE 120 that may communicate in a wireless network, such as wireless network 100. The network node 110 and the UE 120 may communicate via a wireless access link, which may include an uplink and a downlink.

As shown in FIG. 7, and by reference number 705, the network node 110 may send or otherwise provide, and the UE 120 may receive, one or more enhanced SR configurations. For example, as described herein, the one or more enhanced SR configurations may be associated with one or more trigger events or other criteria for dynamically activating and/or deactivating the SR configurations, and/or may be associated with one or more parameters that are jointly adapted or configured in accordance with uplink grant availability and/or a power saving configuration (e.g., a DRX state). Furthermore, as described herein, the SR configurations may be dynamically adapted to increase SR resource availability, or additional SR resources may be dynamically allocated, in accordance with one or more predictions related to when and/or how much uplink data will arrive in an uplink buffer at the UE 120 at a future time. Additionally, or alternatively, one or more SR configurations may be associated with mixed PUCCH formats, such as a single-bit PUCCH format and a multi-bit PUCCH format, such that the SR configuration(s) associated with the mixed PUCCH formats can be used for SRs associated with any suitable type or priority.

In some aspects, one or more SR configurations provided or otherwise configured for the UE 120 may be jointly adapted with a PDCCH configuration that may impact uplink grant availability. For example, an SR configuration may be mapped to or otherwise associated with a PDCCH search space, where the SR configuration and the PDCCH search space each have a respective periodicity. In some aspects, an SR configuration associated with a short periodicity (e.g., to enable low latency between uplink data arrival and an SR to request an uplink grant) may be associated with a PDCCH search space that has a short periodicity (e.g., for a high-throughput mode where there are frequent downlink data transmissions to schedule). In this way, by mapping an SR configuration associated with a short periodicity and a PDCCH search space with a short periodicity, the UE 120 may transmit an SR in a PUCCH occasion soon after uplink data arrives or an SR is otherwise triggered due to the short SR periodicity, and the UE 120 may receive a PDCCH that carries a corresponding uplink grant promptly due to the short PDCCH search space periodicity. In contrast, in cases where an SR configuration with a short periodicity is associated with a PDCCH search space having a long periodicity, the UE 120 would be able to request an uplink grant quickly, but the uplink grant would not be scheduled promptly due to the long periodicity of the PDCCH search space. Accordingly, when the network node 110 configures a mapping between an SR configuration and a PDCCH search space, the SR configuration and the PDCCH search space may generally have the same or similar periodicities such that uplink grant latency is consistent with the SR resource latency.

In some aspects, as described herein, one or more SR configurations provided or otherwise configured for the UE 120 may be associated with one or more trigger events for activating and/or deactivating the SR configurations. For example, in some aspects, the network node 110 may send or otherwise provide, and the UE 120 may receive, one or more RRC messages that configure a set of candidate SR configurations, and the trigger events for activating and/or deactivating the candidate SR configurations may occur when the network node 110 sends, and the UE 120 receives, L1 signaling (e.g., a DCI message) or L2 signaling (e.g., a MAC-CE) that includes an indication to dynamically activate or deactivate one or more candidate SR configurations in the configured set of candidate SR configurations. Additionally, or alternatively, one or more SR configurations may be associated with autonomous activation or deactivation, where the UE 120 autonomously activates an SR configuration associated with a monitored PDCCH search space and deactivates one or more SR configurations associated with PDCCH search spaces that are not monitored.

Additionally, or alternatively, the network node 110 may configure a fallback mechanism, where one candidate SR configuration is configured as, or otherwise designated to be, a default SR configuration that the UE 120 is to activate when the UE 120 and the network node 110 are in an unsynchronized state. For example, in some aspects, the network node 110 may configure a timer associated with the default SR configuration, and the UE 120 may start or restart the timer each time that the UE 120 receives a scheduling DCI with an uplink grant for a new uplink data transmission. Accordingly, the UE 120 may then autonomously switch to (e.g., activate) the default SR configuration if and/or when the timer expires.

Additionally, or alternatively, SR configurations and/or SR resources associated with a high priority (e.g., based on a priority index equaling, exceeding, or otherwise satisfying a threshold) may be associated with a DRX state. For example, in some aspects, the UE 120 may be configured to deactivate high-priority SR configurations and/or SR resources when entering a DRX inactive time, and to activate high-priority SR configurations and/or SR resources when starting a DRX on duration and/or after receiving a wakeup signal during the DRX inactive time.

In some aspects, one or more of the SR configurations provided for the UE 120 may be associated with mixed (e.g., different) PUCCH formats, such as a single-bit PUCCH format and a multi-bit PUCCH format, which may be enabled using the SR configuration(s) for any suitable SR request type. For example, as shown by reference number 710, an SR configuration associated with the mixed PUCCH formats may be associated with a first set of PUCCH occasions (or SR occasions) for the single-bit PUCCH format, and may be associated with a second set of PUCCH occasions (or SR occasions) for the multi-bit PUCCH format. For example, the network node 110 may configure a first start offset and periodicity for the SR occasions associated with the single-bit PUCCH format and a second start offset and periodicity for the SR occasions associated with the multi-bit PUCCH format, where the start offsets and periodicities uniquely specify the respective time domain locations for the SR occasions associated with each PUCCH format. In some aspects, the PUCCH occasions associated with the single-bit PUCCH format (e.g., PUCCH format 0 or 1) may be limited to use for high-priority SRs, and the PUCCH occasions associated with the multi-bit PUCCH format (e.g., PUCCH format 3 or 4) may be used for any SR (including high-priority SRs). Accordingly, in some aspects, the SR occasions associated with the single-bit PUCCH format may have a shorter periodicity than the SR occasions associated with the multi-bit PUCCH format (e.g., to reduce latency for high-priority SRs). Furthermore, in any SR occasions where the single-bit PUCCH format and the multi-bit PUCCH format overlap, the multi-bit PUCCH format is used. In this way, the SR configuration(s) associated with the mixed PUCCH formats may avoid a hard partition between SR resources configured for different SR types. Furthermore, in some aspects, the SR occasions associated with the single-bit PUCCH format (for high-priority SRs) may be dynamically activated only when needed to reduce SR latency for high-priority uplink traffic, and may be dynamically deactivated to conserve resources when there is a low amount of high-priority uplink traffic.

As shown by reference number 715, the UE 120 may activate and/or deactivate one or more SR configurations in accordance with one or more trigger events, criteria, or other suitable conditions. For example, in some aspects, the UE 120 may autonomously activate one or more SR configurations associated with a PDCCH search space that the UE 120 is configured to monitor, and may deactivate any SR configurations associated with a PDCCH search space other than the PDCCH search space that the UE 120 is configured to monitor. Additionally, or alternatively, the UE 120 may deactivate one or more SR configurations associated with high-priority SR resources (e.g., a priority index that satisfies a threshold) in accordance with the UE 120 preparing to enter a DRX inactive time. Additionally, or alternatively, the UE 120 may activate one or more SR configurations associated with high-priority SR resources in accordance with the UE 120 preparing to start a DRX on duration and/or in response to receiving a wakeup signal during the DRX inactive time. Additionally, or alternatively, the UE 120 may activate one or more SR configurations and/or may deactivate one or more SR configurations indicated in L1/L2 signaling received from the network node 110 (e.g., from the configured set of candidate SR configurations).

As shown by reference number 720, the UE 120 may determine that an SR is triggered (e.g., in accordance with new uplink data arriving in an uplink buffer, buffered uplink data having a size that satisfies a threshold, and/or an SR periodicity associated with an activated SR configuration having elapsed). In some aspects, as shown by reference number 725, the UE 120 may transmit, and the network node 110 may receive or otherwise obtain, the SR in a PUCCH occasion associated with the activated SR configuration. For example, in cases where the triggered SR is associated with uplink traffic having a priority that equals, exceeds, or otherwise satisfies a threshold, the SR may be transmitted in a next available SR occasion or PUCCH occasion, which may be associated with the single-bit PUCCH format or the multi-bit PUCCH format. Alternatively, in cases where the triggered SR is associated with uplink traffic having a priority that equals, is below, or otherwise fails to satisfy a threshold, the SR may be transmitted in a next available SR occasion or PUCCH occasion associated with the multi-bit PUCCH format. In some aspects, in cases where the SR is associated with the multi-bit PUCCH format, the SR may include one bit to request an uplink grant, and one or more additional bits to indicate the priority associated with the SR (e.g., a ‘0’ to indicate a low priority or a ‘1’ to indicate a high priority, or the priority may be indicated using multiple bits to enable more than two priority levels). In some aspects, the SR associated with the multi-bit PUCCH format may further include one or more bits to indicate a trigger, a cause, a reason, an event, or other suitable information associated with the SR (e.g., to initiate BFR for a TRP or an Scell, to activate or deactivate a measurement gap, and/or to indicate an uplink buffer size, among other examples).

Alternatively, as described herein, the UE 120 may obtain a prediction (e.g., using an AI/ML model or other suitable predictive techniques, such as statistical analysis) that new uplink data will arrive in an uplink buffer at a future time. For example, in some cases, dynamically adapting (e.g., activating and/or deactivating) SR configurations may result in high-priority uplink traffic arriving at the UE 120 when SR resources are unavailable (e.g., because an SR configuration to support high-priority uplink traffic is deactivated). Accordingly, in some aspects, predictive information related to when and/or how much new uplink data will arrive in an uplink buffer may be used to proactively request SR resources before the new uplink data arrives in the uplink buffer. For example, as shown by reference number 730, the UE 120 may transmit a predictive BSR or a predictive SR to the network node 110 prior to the SR in order to request SR resource adaptation based on a prediction that new uplink data will arrive in the uplink buffer, and the network node 110 may respond by activating or otherwise allocating high-priority SR resources before the new uplink data arrives, to reduce or avoid delay associated with the SR to be transmitted after the new uplink data arrives.

For example, in some aspects, the predictive information that the UE 120 provides to the network node 110 may be a predictive BSR in cases where the UE 120 is able to predict the amount of uplink data that is expected to arrive in the uplink buffer. In such cases, the predictive BSR may indicate an index associated with one or more LCH groups (LCGs) associated with the incoming uplink data, a size of the incoming uplink data for each LCG, and/or a number of slots, symbols, or other TTIs until the incoming uplink data is expected to arrive. Alternatively, the predictive information that the UE 120 provides to the network node 110 may be a predictive SR in cases where the UE 120 is unable to predict the amount of uplink data that is expected to arrive in the uplink buffer. In such cases, the predictive SR may include a multi-bit payload to indicate indexes associated with one or more LCGs associated with the incoming uplink data and/or a number of slots, symbols, or other TTIs until the incoming uplink data is expected to arrive. In some aspects, the UE 120 may transmit the predictive BSR or predictive SR in accordance with one or more conditions being satisfied. For example, to prevent the UE 120 from reporting excessive predictive BSRs and/or predictive SRs, the network node 110 may configure the UE 120 to report predictive information related to the arrival of uplink data only when high priority SR resources are deactivated, when a predicted arrival time of the new uplink data is within a future time window (e.g., a predicted arrival time of the new uplink data is less than or equal to X milliseconds and greater than or equal to Y milliseconds), and/or no other predictive BSRs and/or predictive SRs have been triggered within a threshold time period (e.g., within the past Z milliseconds).

As further shown by reference number 735, the UE 120 may monitor a PDCCH search space after transmitting the SR. For example, as described herein, the UE 120 may monitor the PDCCH search space for an uplink grant that is responsive to the SR. Furthermore, the PDCCH search space that the UE 120 monitors may be mapped to or otherwise associated with the activated SR configuration associated with the SR transmitted to the network node 110 (e.g., the activated SR configuration may be determined according to which PDCCH search space the UE 120 monitors). In some aspects, the monitored PDCCH search space may have the same or a similar periodicity as the SR configuration associated with the PDCCH search space. As further shown by reference number 740, the network node 110 may then process the SR and allocate uplink resources according to various factors (e.g., resource availability, channel conditions, and/or QoS requirements, among other examples), and may send or otherwise provide a PDCCH that carries scheduling DCI that indicates the uplink grant to the UE 120. As shown by reference number 745, the UE 120 may then start or restart a fallback timer that is used to automatically switch to a default SR configuration when the UE 120 and the network node 110 are in an unsynchronized state. As further shown by reference number 750, the UE 120 may transmit the uplink data to the network node 110 in a PUSCH using a PUSCH resource indicated in the uplink grant. As further shown by reference number 755, the UE 120 may optionally activate the default SR configuration if the fallback timer expires before the UE 120 receives another scheduling DCI from the network node 110.

As indicated above, FIG. 7 is provided as an example. Other examples may differ from what is described with regard to FIG. 7.

FIG. 8 is a diagram illustrating an example process 800 performed, for example, at a UE or an apparatus of a UE, in accordance with the present disclosure. Example process 800 is an example where the apparatus or the UE (e.g., UE 120) performs operations associated with enhanced SR configurations.

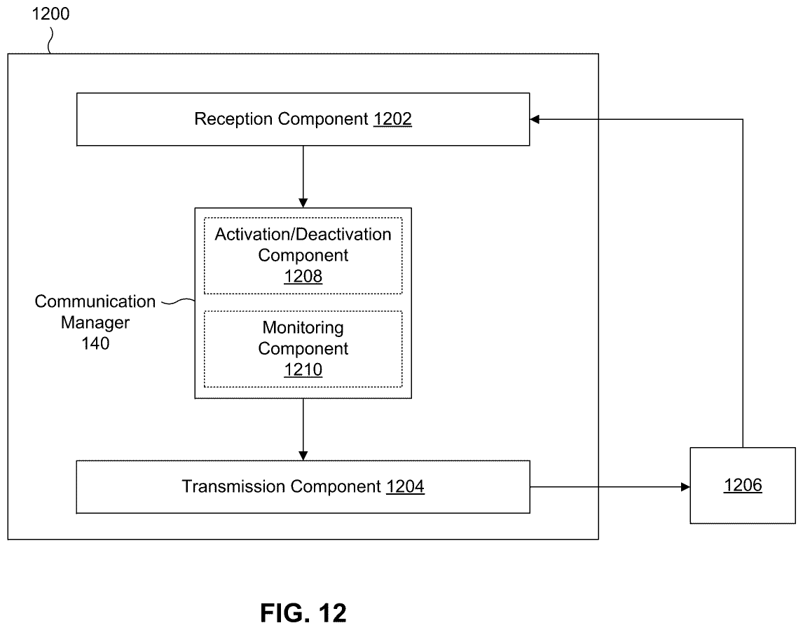

As shown in FIG. 8, in some aspects, process 800 may include receiving an SR configuration (block 810). For example, the UE (e.g., using communication manager 140 and/or reception component 1202, depicted in FIG. 12) may receive an SR configuration, as described above.

As further shown in FIG. 8, in some aspects, process 800 may include activating the SR configuration in accordance with a trigger event (block 820). For example, the UE (e.g., using communication manager 140 and/or activation/deactivation component 1208, depicted in FIG. 12) may activate the SR configuration in accordance with a trigger event, as described above.

As further shown in FIG. 8, in some aspects, process 800 may include transmitting an SR in a PUCCH occasion associated with the SR configuration (block 830). For example, the UE (e.g., using communication manager 140 and/or transmission component 1204, depicted in FIG. 12) may transmit an SR in a PUCCH occasion associated with the SR configuration, as described above.

As further shown in FIG. 8, in some aspects, process 800 may include monitoring a PDCCH search space for a PDCCH that carries an uplink grant associated with the SR (block 840). For example, the UE (e.g., using communication manager 140 and/or monitoring component 1210, depicted in FIG. 12) may monitor a PDCCH search space for a PDCCH that carries an uplink grant associated with the SR, as described above.

Process 800 may include additional aspects, such as any single aspect or any combination of aspects described below and/or in connection with one or more other processes described elsewhere herein.

In a first aspect, the SR configuration is associated with the PDCCH search space.

In a second aspect, alone or in combination with the first aspect, activating the SR configuration in accordance with the trigger event comprises activating the SR configuration based at least in part on the PDCCH search space associated with the SR configuration being a monitored PDCCH search space.

In a third aspect, alone or in combination with one or more of the first and second aspects, activating the SR configuration in accordance with the trigger event comprises deactivating one or more SR configurations that are associated with other PDCCH search spaces based at least in part on the PDCCH search space associated with the SR configuration being a monitored PDCCH search space.

In a fourth aspect, alone or in combination with one or more of the first through third aspects, process 800 includes receiving a configuration designating the SR configuration to be used in an unsynchronized state, and activating the SR configuration in accordance with a condition associated with the unsynchronized state being satisfied.

In a fifth aspect, alone or in combination with one or more of the first through fourth aspects, activating the SR configuration in accordance with the trigger event comprises starting a timer in response to receiving scheduling DCI for an uplink data transmission, and activating the SR configuration in accordance with the timer expiring without receiving another scheduling DCI.

In a sixth aspect, alone or in combination with one or more of the first through fifth aspects, process 800 includes deactivating the SR configuration during a DRX inactive time in accordance with the SR configuration having a priority that satisfies a threshold.

In a seventh aspect, alone or in combination with one or more of the first through sixth aspects, activating the SR configuration in accordance with the trigger event comprises activating the SR configuration during a DRX on duration in accordance with the SR configuration having a priority that satisfies a threshold.

In an eighth aspect, alone or in combination with one or more of the first through seventh aspects, process 800 includes receiving a wakeup signal during a DRX inactive time, and activating the SR configuration in accordance with receiving the wakeup signal.

In a ninth aspect, alone or in combination with one or more of the first through eighth aspects, process 800 includes receiving one or more RRC messages configuring a set of candidate SR configurations, receiving an indication to activate one or more candidate SR configurations, from the set of candidate SR configurations, and activating the SR configuration in accordance with the SR configuration being among the one or more candidate SR configurations associated with the indication.

In a tenth aspect, alone or in combination with one or more of the first through ninth aspects, process 800 includes receiving one or more RRC messages configuring a set of candidate SR configurations, receiving an indication to deactivate one or more candidate SR configurations, from the set of candidate SR configurations, and deactivating the SR configuration in accordance with the SR configuration being among the one or more candidate SR configurations associated with the indication.

In an eleventh aspect, alone or in combination with one or more of the first through tenth aspects, process 800 includes obtaining a prediction that uplink data will arrive in an uplink buffer, and transmitting predictive information to activate the SR configuration before the uplink data arrives in the uplink buffer.

In a twelfth aspect, alone or in combination with one or more of the first through eleventh aspects, the prediction is associated with an AI/ML model.

In a thirteenth aspect, alone or in combination with one or more of the first through twelfth aspects, the predictive information is transmitted based at least in part on the uplink data predicted to arrive in the uplink buffer having a size that satisfies a threshold.

In a fourteenth aspect, alone or in combination with one or more of the first through thirteenth aspects, the predictive information includes a predictive buffer status report indicating an index of a logical channel group associated with the uplink data predicted to arrive in the uplink buffer, a size of the uplink data predicted to arrive in the uplink buffer, a number of transmission time intervals until the uplink data is predicted to arrive in the uplink buffer, or a combination thereof.

In a fifteenth aspect, alone or in combination with one or more of the first through fourteenth aspects, the predictive information includes a predictive SR based at least in part on the uplink data predicted to arrive in the uplink buffer having an unknown size.

In a sixteenth aspect, alone or in combination with one or more of the first through fifteenth aspects, the predictive information includes a predictive SR indicating an index of a logical channel group associated with the uplink data predicted to arrive in the uplink buffer, a number of transmission time intervals until the uplink data is predicted to arrive in the uplink buffer, or a combination thereof.

In a seventeenth aspect, alone or in combination with one or more of the first through sixteenth aspects, process 800 includes receiving information configuring one or more conditions for reporting the predictive information, wherein the predictive information is transmitted based at least in part on the one or more conditions being satisfied.

In an eighteenth aspect, alone or in combination with one or more of the first through seventeenth aspects, the one or more conditions include high-priority SR resources being deactivated, a predicted arrival time of the uplink data being less than or equal to a first threshold, a predicted arrival time of the uplink data being greater than or equal to a second threshold, no predictive information having been transmitted within a threshold duration, or a combination thereof.

In a nineteenth aspect, alone or in combination with one or more of the first through eighteenth aspects, process 800 includes receiving, in a PDCCH occasion associated with the monitored PDCCH search space, the PDCCH that carries the uplink grant associated with the SR, and transmitting uplink data in a PUSCH resource indicated in the uplink grant.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with enhanced scheduling request configurations.

As shown in FIG. 9, in some aspects, process 900 may include receiving an SR configuration associated with a single-bit PUCCH format and a multi-bit PUCCH format (block 910). For example, the UE (e.g., using communication manager 140 and/or reception component 1202, depicted in FIG. 12) may receive an SR configuration associated with a single-bit PUCCH format and a multi-bit PUCCH format, as described above.

As further shown in FIG. 9, in some aspects, process 900 may include transmitting an SR associated with a PUCCH format selected from the single-bit PUCCH format and the multi-bit PUCCH format (block 920). For example, the UE (e.g., using communication manager 140 and/or transmission component 1204, depicted in FIG. 12) may transmit an SR associated with a PUCCH format selected from the single-bit PUCCH format and the multi-bit PUCCH format, as described above.

As further shown in FIG. 9, in some aspects, process 900 may include monitoring a PDCCH search space for a PDCCH that carries an uplink grant associated with the SR (block 930). For example, the UE (e.g., using communication manager 140 and/or monitoring component 1210, depicted in FIG. 12) may monitor a PDCCH search space for a PDCCH that carries an uplink grant associated with the SR, as described above.

Process 900 may include additional aspects, such as any single aspect or any combination of aspects described below and/or in connection with one or more other processes described elsewhere herein.

In a first aspect, the SR includes one bit to request the uplink grant and one or more bits to indicate a priority associated with the request in accordance with the selected PUCCH format being the multi-bit PUCCH format.

In a second aspect, alone or in combination with the first aspect, the SR includes one or more bits to indicate a trigger associated with the SR in accordance with the selected PUCCH format being the multi-bit PUCCH format.

In a third aspect, alone or in combination with one or more of the first and second aspects, the selected PUCCH format is the single-bit PUCCH format in accordance with the SR having a priority that satisfies a threshold.

In a fourth aspect, alone or in combination with one or more of the first through third aspects, the SR is transmitted in a PUCCH occasion associated with the selected PUCCH format.

In a fifth aspect, alone or in combination with one or more of the first through fourth aspects, the selected PUCCH format is the multi-bit PUCCH format in accordance with the SR being transmitted in a PUCCH occasion associated with the single-bit PUCCH format and the multi-bit PUCCH format.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a network node or an apparatus of a network node, in accordance with the present disclosure. Example process 1000 is an example where the apparatus or the network node (e.g., network node 110) performs operations associated with enhanced SR configurations.

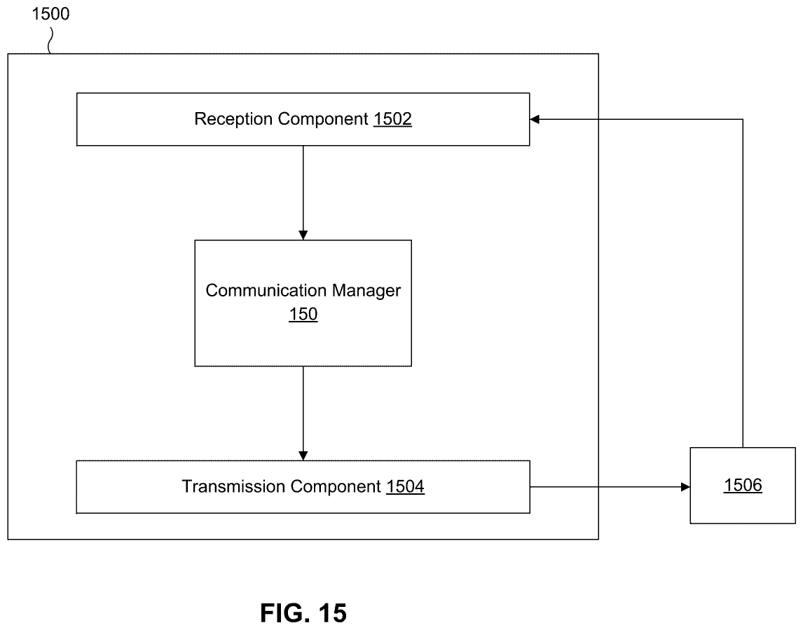

As shown in FIG. 10, in some aspects, process 1000 may include sending an SR configuration associated with a trigger event for activating the SR configuration (block 1010). For example, the network node (e.g., using communication manager 150 and/or transmission component 1504, depicted in FIG. 15) may send an SR configuration associated with a trigger event for activating the SR configuration, as described above.

As further shown in FIG. 10, in some aspects, process 1000 may include obtaining an SR in a PUCCH occasion associated with the SR configuration (block 1020). For example, the network node (e.g., using communication manager 150 and/or reception component 1502, depicted in FIG. 15) may obtain an SR in a PUCCH occasion associated with the SR configuration, as described above.

Process 1000 may include additional aspects, such as any single aspect or any combination of aspects described below and/or in connection with one or more other processes described elsewhere herein.

In a first aspect, the SR configuration is associated with a PDCCH search space.

In a second aspect, alone or in combination with the first aspect, process 1000 includes sending a configuration designating the SR configuration associated to be used in an unsynchronized state.

In a third aspect, alone or in combination with one or more of the first and second aspects, process 1000 includes sending information configuring a timer to be started when scheduling DCI for an uplink data transmission is received, and sending an indication to activate the SR configuration when the timer expires.

In a fourth aspect, alone or in combination with one or more of the first through third aspects, the SR configuration is deactivated during a DRX inactive time in accordance with the SR configuration having a priority that satisfies a threshold.

In a fifth aspect, alone or in combination with one or more of the first through fourth aspects, the SR configuration is activated during a DRX on duration in accordance with the SR configuration having a priority that satisfies a threshold.

In a sixth aspect, alone or in combination with one or more of the first through fifth aspects, process 1000 includes sending a wakeup signal during a DRX inactive time, wherein the wakeup signal activates the SR configuration.

In a seventh aspect, alone or in combination with one or more of the first through sixth aspects, process 1000 includes sending one or more RRC messages configuring a set of candidate SR configurations, and sending an indication to activate one or more candidate SR configurations, from the set of candidate SR configurations.

In an eighth aspect, alone or in combination with one or more of the first through seventh aspects, process 1000 includes sending one or more RRC messages configuring a set of candidate SR configurations, and sending an indication to deactivate one or more candidate SR configurations, from the set of candidate SR configurations.

In a ninth aspect, alone or in combination with one or more of the first through eighth aspects, process 1000 includes obtaining predictive information to activate the SR configuration before uplink data arrives in an uplink buffer.

In a tenth aspect, alone or in combination with one or more of the first through ninth aspects, the predictive information is associated with an AI/ML model.

In an eleventh aspect, alone or in combination with one or more of the first through tenth aspects, the predictive information includes a predictive buffer status report indicating an index of a logical channel group associated with the uplink data predicted to arrive in the uplink buffer, a size of the uplink data predicted to arrive in the uplink buffer, a number of transmission time intervals until the uplink data is predicted to arrive in the uplink buffer, or a combination thereof.

In a twelfth aspect, alone or in combination with one or more of the first through eleventh aspects, the predictive information includes a predictive SR indicating an index of a logical channel group associated with the uplink data predicted to arrive in the uplink buffer, a number of transmission time intervals until the uplink data is predicted to arrive in the uplink buffer, or a combination thereof.

In a thirteenth aspect, alone or in combination with one or more of the first through twelfth aspects, process 1000 includes sending information configuring one or more conditions for reporting the predictive information, wherein the predictive information is transmitted based at least in part on the one or more conditions being satisfied.

In a fourteenth aspect, alone or in combination with one or more of the first through thirteenth aspects, the one or more conditions include high-priority SR resources being deactivated, a predicted arrival time of the uplink data being less than or equal to a first threshold, a predicted arrival time of the uplink data being greater than or equal to a second threshold, no predictive information having been transmitted within a threshold duration, or a combination thereof.

In a fifteenth aspect, alone or in combination with one or more of the first through fourteenth aspects, process 1000 includes sending, in a PDCCH occasion, a PDCCH that carries an uplink grant associated with the SR, and obtaining uplink data in a PUSCH resource indicated in the uplink grant.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node, in accordance with the present disclosure. Example process 1100 is an example where the apparatus or the network node (e.g., network node 110) performs operations associated with enhanced SR configurations.

As shown in FIG. 11, in some aspects, process 1100 may include sending an SR configuration associated with a single-bit PUCCH format and a multi-bit PUCCH format (block 1110). For example, the network node (e.g., using communication manager 150 and/or transmission component 1504, depicted in FIG. 15) may send an SR configuration associated with a single-bit PUCCH format and a multi-bit PUCCH format, as described above.

As further shown in FIG. 11, in some aspects, process 1100 may include obtaining an SR associated with a PUCCH format selected from the single-bit PUCCH format and the multi-bit PUCCH format (block 1120). For example, the network node (e.g., using communication manager 150 and/or reception component 1502, depicted in FIG. 15) may obtain an SR associated with a PUCCH format selected from the single-bit PUCCH format and the multi-bit PUCCH format, as described above.

Process 1100 may include additional aspects, such as any single aspect or any combination of aspects described below and/or in connection with one or more other processes described elsewhere herein.

In a first aspect, the SR includes one bit to request an uplink grant and one or more bits to indicate a priority associated with the request in accordance with the selected PUCCH format being the multi-bit PUCCH format.

In a second aspect, alone or in combination with the first aspect, the SR includes one or more bits to indicate a trigger associated with the SR in accordance with the selected PUCCH format being the multi-bit PUCCH format.

In a third aspect, alone or in combination with one or more of the first and second aspects, the selected PUCCH format is the single-bit PUCCH format in accordance with the SR having a high priority.

In a fourth aspect, alone or in combination with one or more of the first through third aspects, the SR is transmitted in a PUCCH occasion associated with the selected PUCCH format.

In a fifth aspect, alone or in combination with one or more of the first through fourth aspects, the selected PUCCH format is the multi-bit PUCCH format in accordance with the SR being transmitted in a PUCCH occasion associated with the single-bit PUCCH format and the multi-bit PUCCH format.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 140. The communication manager 140 may include one or more of an activation/deactivation component 1208 or a monitoring component 1210, among other examples.

In some aspects, the apparatus 1200 may be configured to perform one or more operations described herein in connection with FIG. 7. Additionally, or alternatively, the apparatus 1200 may be configured to perform one or more processes described herein, such as process 800 of FIG. 8, process 900 of FIG. 9, or a combination thereof. In some aspects, the apparatus 1200 and/or one or more components shown in FIG. 12 may include one or more components of the UE described in connection with FIG. 1 and FIG. 2. Additionally, or alternatively, one or more components shown in FIG. 12 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, one or more modems, one or more demodulators, one or more MIMO detectors, one or more receive processors, one or more controllers/processors, one or more memories, or a combination thereof, of the UE described in connection with FIG. 1 and FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, one or more modems, one or more modulators, one or more transmit MIMO processors, one or more transmit processors, one or more controllers/processors, one or more memories, or a combination thereof, of the UE described in connection with FIG. 1 and FIG. 2. In some aspects, the transmission component 1204 may be co-located with the reception component 1202 in one or more transceivers.

The reception component 1202 may receive an SR configuration. The activation/deactivation component 1208 may activate the SR configuration in accordance with a trigger event. The transmission component 1204 may transmit an SR in a PUCCH occasion associated with the SR configuration. The monitoring component 1210 may monitor a PDCCH search space for a PDCCH that carries an uplink grant associated with the SR.

The reception component 1202 may receive a configuration designating the SR configuration to be used in an unsynchronized state. The activation/deactivation component 1208 may activate the SR configuration in accordance with a condition associated with the unsynchronized state being satisfied.

The activation/deactivation component 1208 may deactivate the SR configuration during a DRX inactive time in accordance with the SR configuration having a priority that satisfies a threshold.

The reception component 1202 may receive a wakeup signal during a DRX inactive time. The activation/deactivation component 1208 may activate the SR configuration in accordance with receiving the wakeup signal.

The reception component 1202 may receive one or more RRC messages configuring a set of candidate SR configurations. The reception component 1202 may receive an indication to activate one or more candidate SR configurations, from the set of candidate SR configurations. The activation/deactivation component 1208 may activate the SR configuration in accordance with the SR configuration being among the one or more candidate SR configurations associated with the indication.

The reception component 1202 may receive one or more RRC messages configuring a set of candidate SR configurations. The reception component 1202 may receive an indication to deactivate one or more candidate SR configurations, from the set of candidate SR configurations. The activation/deactivation component 1208 may deactivate the SR configuration in accordance with the SR configuration being among the one or more candidate SR configurations associated with the indication.

The reception component 1202 may receive information configuring one or more conditions for reporting the predictive information, wherein the predictive information is transmitted based at least in part on the one or more conditions being satisfied.

The reception component 1202 may receive, in a PDCCH occasion associated with the monitored PDCCH search space, the PDCCH that carries the uplink grant associated with the SR. The transmission component 1204 may transmit uplink data in a PUSCH resource indicated in the uplink grant.

The reception component 1202 may receive an SR configuration associated with a single-bit PUCCH format and a multi-bit PUCCH format. The transmission component 1204 may transmit an SR associated with a PUCCH format selected from the single-bit PUCCH format and the multi-bit PUCCH format. The monitoring component 1210 may monitor a PDCCH search space for a PDCCH that carries an uplink grant associated with the SR.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

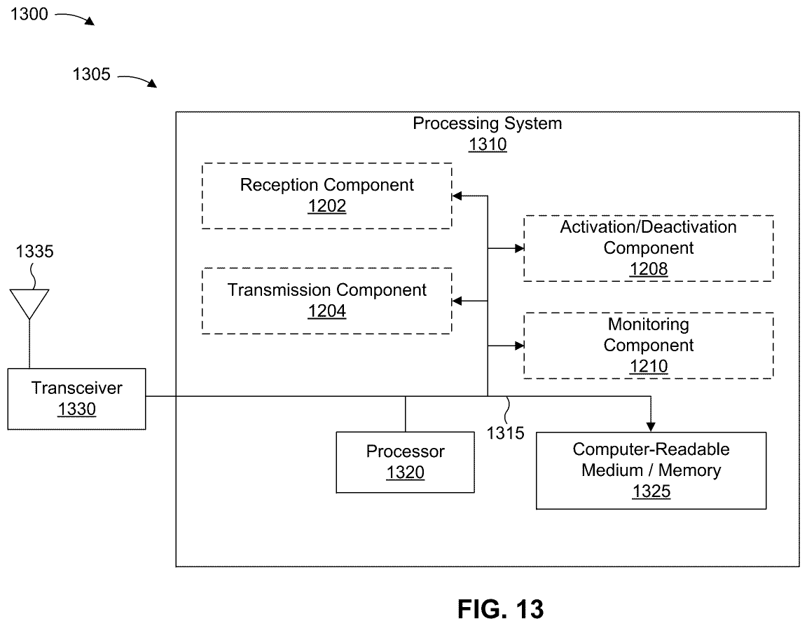

FIG. 13 is a diagram illustrating an example 1300 of a hardware implementation for an apparatus 1305 employing a processing system 1310, in accordance with the present disclosure. The apparatus 1305 may be a UE or may be at (e.g., included in) a UE.

The processing system 1310 may be implemented with a bus architecture, represented generally by the bus 1315. The bus 1315 may include any number of interconnecting buses and bridges depending on the specific application of the processing system 1310 and the overall design constraints. The bus 1315 links together various circuits including one or more processors and/or hardware components, represented by the processor 1320, the illustrated components, and the computer-readable medium/memory 1325. The bus 1315 may also link various other circuits, such as timing sources, peripherals, voltage regulators, and/or power management circuits.

The processing system 1310 may be coupled to one or more transceivers 1330. A transceiver 1330 is coupled to one or more antennas 1335. The transceiver 1330 provides a means for communicating with various other apparatuses over a transmission medium. The transceiver 1330 receives a signal from the one or more antennas 1335, extracts information from the received signal, and provides the extracted information to the processing system 1310, specifically the reception component 1202. In addition, the transceiver 1330 receives information from the processing system 1310, specifically the transmission component 1204, and generates a signal to be applied to the one or more antennas 1335 based at least in part on the received information.

The processing system 1310 includes one or more processors 1320 coupled to a computer-readable medium/memory 1325. A processor 1320 is responsible for general processing, including the execution of software stored on the computer-readable medium/memory 1325. The software, when executed by the processor 1320, causes the processing system 1310 to perform the various functions described herein for any particular apparatus. The computer-readable medium/memory 1325 may also be used for storing data that is manipulated by the processor 1320 when executing software. The processing system further includes at least one of the illustrated components. The components may be software modules running in the processor 1320, resident/stored in the computer readable medium/memory 1325, one or more hardware modules coupled to the processor 1320, or some combination thereof.

In some aspects, the processing system 1310 may be a component of the UE 120 and may include one or more memories, such as the memory 282, and/or may include one or more processors, such as at least one of the TX MIMO processor 266, the receive processor 258, and/or the controller/processor 280. In some aspects, the apparatus 1305 for wireless communication includes means for receiving an SR configuration, means for activating the SR configuration in accordance with a trigger event, means for transmitting an SR in a PUCCH occasion associated with the SR configuration, and/or means for monitoring a PDCCH search space for a PDCCH that carries an uplink grant associated with the SR. Additionally, or alternatively, the apparatus 1305 for wireless communication includes means for receiving an SR configuration associated with a single-bit PUCCH format and a multi-bit PUCCH format, means for transmitting an SR associated with a PUCCH format selected from the single-bit PUCCH format and the multi-bit PUCCH format, and/or means for monitoring a PDCCH search space for a PDCCH that carries an uplink grant associated with the SR. The aforementioned means may be one or more of the aforementioned components of the apparatus 1200 and/or the processing system 1310 of the apparatus 1305 configured to perform the functions recited by the aforementioned means. As described elsewhere herein, the processing system 1310 may include the TX MIMO processor 266, the RX processor 258, and/or the controller/processor 280. In one configuration, the aforementioned means may be the TX MIMO processor 266, the RX processor 258, and/or the controller/processor 280 configured to perform the functions and/or operations recited herein.

FIG. 13 is provided as an example. Other examples may differ from what is described in connection with FIG. 13.

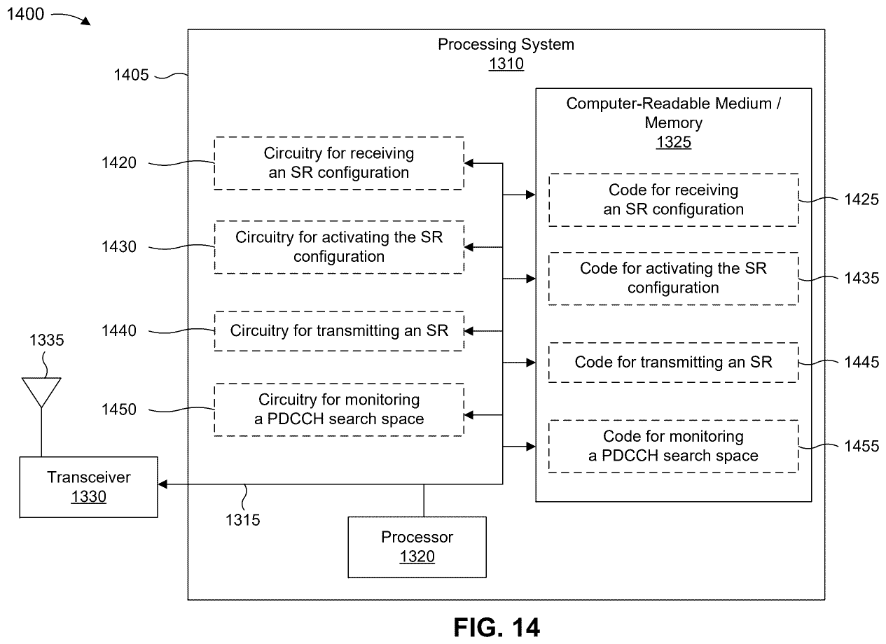

FIG. 14 is a diagram illustrating an example 1400 of an implementation of code and circuitry for an apparatus 1405, in accordance with the present disclosure. The apparatus 1405 may be a UE, or a UE may include the apparatus 1405.

As shown in FIG. 14, the apparatus 1405 may include circuitry for receiving an SR configuration (circuitry 1420). For example, the circuitry 1420 may enable the apparatus 1405 to receive an SR configuration. Additionally, or alternatively, the circuitry 1420 may enable the apparatus 1405 to receive an SR configuration associated with a single-bit PUCCH format and a multi-bit PUCCH format.

As shown in FIG. 14, the apparatus 1405 may include, stored in computer-readable medium 1325, code for receiving an SR configuration (code 1425). For example, the code 1425, when executed by processor 1320, may cause processor 1320 to cause transceiver 1330 to receive an SR configuration. Additionally, or alternatively, the code 1425, when executed by processor 1320, may cause processor 1320 to cause transceiver 1330 to receive an SR configuration associated with a single-bit PUCCH format and a multi-bit PUCCH format.

As shown in FIG. 14, the apparatus 1405 may include circuitry for activating the SR configuration in accordance with a trigger event (circuitry 1430). For example, the circuitry 1430 may enable the apparatus 1405 to activate the SR configuration in accordance with a trigger event.

As shown in FIG. 14, the apparatus 1405 may include, stored in computer-readable medium 1325, code for activating the SR configuration in accordance with a trigger event (code 1435). For example, the code 1435, when executed by processor 1320, may cause processor 1320 to activate the SR configuration in accordance with a trigger event.

As shown in FIG. 14, the apparatus 1405 may include circuitry for transmitting an SR in a PUCCH occasion associated with the SR configuration (circuitry 1440). For example, the circuitry 1440 may enable the apparatus 1405 to transmit an SR in a PUCCH occasion associated with the SR configuration. Additionally, or alternatively, the circuitry 1440 may enable the apparatus 1405 to transmit an SR associated with a PUCCH format selected from the single-bit PUCCH format and the multi-bit PUCCH format.

As shown in FIG. 14, the apparatus 1405 may include, stored in computer-readable medium 1325, code for transmitting an SR in a PUCCH occasion associated with the SR configuration (code 1445). For example, the code 1445, when executed by processor 1320, may cause processor 1320 to cause transceiver 1330 to transmit an SR in a PUCCH occasion associated with the SR configuration. Additionally, or alternatively, the code 1445, when executed by processor 1320, may cause processor 1320 to cause transceiver 1330 to transmit an SR associated with a PUCCH format selected from the single-bit PUCCH format and the multi-bit PUCCH format.

As shown in FIG. 14, the apparatus 1405 may include circuitry for monitoring a PDCCH search space for a PDCCH that carries an uplink grant associated with the SR (circuitry 1450). For example, the circuitry 1450 may enable the apparatus 1405 to monitor a PDCCH search space for a PDCCH that carries an uplink grant associated with the SR.

As shown in FIG. 14, the apparatus 1405 may include, stored in computer-readable medium 1325, code for monitoring a PDCCH search space for a PDCCH that carries an uplink grant associated with the SR (code 1455). For example, the code 1455, when executed by processor 1320, may cause processor 1320 to monitor a PDCCH search space for a PDCCH that carries an uplink grant associated with the SR.

FIG. 14 is provided as an example. Other examples may differ from what is described in connection with FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include the communication manager 150.

In some aspects, the apparatus 1500 may be configured to perform one or more operations described herein in connection with FIG. 7. Additionally, or alternatively, the apparatus 1500 may be configured to perform one or more processes described herein, such as process 1000 of FIG. 10, process 1100 of FIG. 11, or a combination thereof. In some aspects, the apparatus 1500 and/or one or more components shown in FIG. 15 may include one or more components of the network node described in connection with FIG. 1 and FIG. 2. Additionally, or alternatively, one or more components shown in FIG. 15 may be implemented within one or more components described in connection with FIG. 1 and FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1500. In some aspects, the reception component 1502 may include one or more antennas, one or more modems, one or more demodulators, one or more MIMO detectors, one or more receive processors, one or more controllers/processors, one or more memories, or a combination thereof, of the network node described in connection with FIG. 1 and FIG. 2.

The transmission component 1504 may transmit communications, such as reference signals, control information, data communications, or a combination thereof, to the apparatus 1506. In some aspects, one or more other components of the apparatus 1500 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, one or more modems, one or more modulators, one or more transmit MIMO processors, one or more transmit processors, one or more controllers/processors, one or more memories, or a combination thereof, of the network node described in connection with FIG. 1 and FIG. 2. In some aspects, the transmission component 1504 may be co-located with the reception component 1502 in one or more transceivers.

The communication manager 150 or transmission component 1504 may send an SR configuration associated with a trigger event for activating the SR configuration. The communication manager 150 or reception component 1502 may obtain an SR in a PUCCH occasion associated with the SR configuration.

The communication manager 150 or transmission component 1504 may send a configuration designating the SR configuration associated to be used in an unsynchronized state.

The communication manager 150 or transmission component 1504 may send information configuring a timer to be started when scheduling DCI for an uplink data transmission is received. The communication manager 150 or transmission component 1504 may send an indication to activate the SR configuration when the timer expires.

The communication manager 150 or transmission component 1504 may send a wakeup signal during a DRX inactive time, wherein the wakeup signal activates the SR configuration.

The communication manager 150 or transmission component 1504 may send one or more RRC messages configuring a set of candidate SR configurations. The communication manager 150 or transmission component 1504 send an indication to activate one or more candidate SR configurations, from the set of candidate SR configurations.

The communication manager 150 or transmission component 1504 may send one or more RRC messages configuring a set of candidate SR configurations. The communication manager 150 or transmission component 1504 may send an indication to deactivate one or more candidate SR configurations, from the set of candidate SR configurations.

The communication manager 150 or reception component 1502 may obtain predictive information to activate the SR configuration before uplink data arrives in an uplink buffer.

The communication manager 150 or transmission component 1504 may send information configuring one or more conditions for reporting the predictive information, wherein the predictive information is transmitted based at least in part on the one or more conditions being satisfied.

The communication manager 150 or transmission component 1504 may send, in a PDCCH occasion, a PDCCH that carries an uplink grant associated with the SR. The communication manager 150 or reception component 1502 may obtain uplink data in a PUSCH resource indicated in the uplink grant.

The communication manager 150 or transmission component 1504 may send an SR configuration associated with a single-bit PUCCH format and a multi-bit PUCCH format. The communication manager 150 or reception component 1502 may obtain an SR associated with a PUCCH format selected from the single-bit PUCCH format and the multi-bit PUCCH format.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

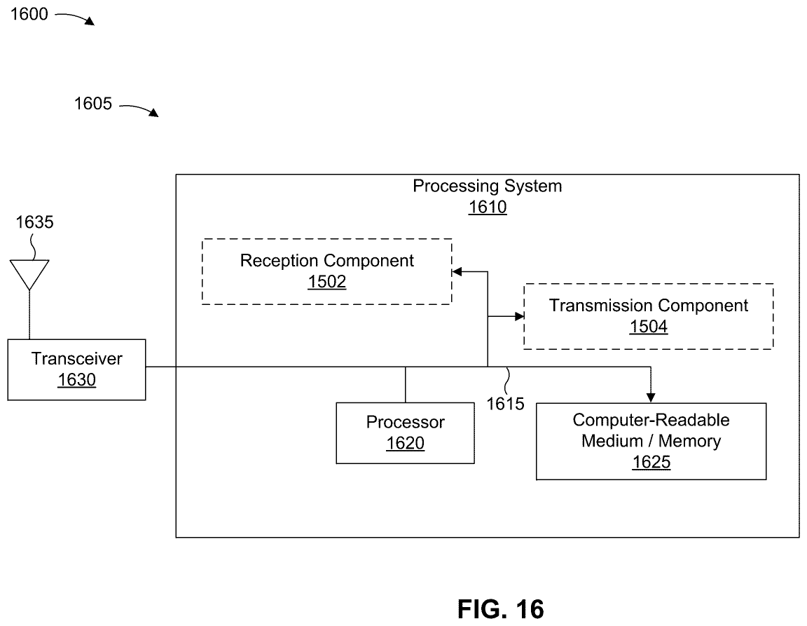

FIG. 16 is a diagram illustrating an example 1600 of a hardware implementation for an apparatus 1605 employing a processing system 1610, in accordance with the present disclosure. The apparatus 1605 may be a network node or may be at (e.g., included in) a network node.

The processing system 1610 may be implemented with a bus architecture, represented generally by the bus 1615. The bus 1615 may include any number of interconnecting buses and bridges depending on the specific application of the processing system 1610 and the overall design constraints. The bus 1615 links together various circuits including one or more processors and/or hardware components, represented by the processor 1620, the illustrated components, and the computer-readable medium/memory 1625. The bus 1615 may also link various other circuits, such as timing sources, peripherals, voltage regulators, and/or power management circuits.

The processing system 1610 may be coupled to one or more transceivers 1630. A transceiver 1630 is coupled to one or more antennas 1635. The transceiver 1630 provides a means for communicating with various other apparatuses over a transmission medium. The transceiver 1630 receives a signal from the one or more antennas 1635, extracts information from the received signal, and provides the extracted information to the processing system 1610, specifically the reception component 1502. In addition, the transceiver 1630 receives information from the processing system 1610, specifically the transmission component 1504, and generates a signal to be applied to the one or more antennas 1635 based at least in part on the received information.

The processing system 1610 includes one or more processors 1620 coupled to a computer-readable medium/memory 1625. A processor 1620 is responsible for general processing, including the execution of software stored on the computer-readable medium/memory 1625. The software, when executed by the processor 1620, causes the processing system 1610 to perform the various functions described herein for any particular apparatus. The computer-readable medium/memory 1625 may also be used for storing data that is manipulated by the processor 1620 when executing software.

The processing system further includes at least one of the illustrated components. The components may be software modules running in the processor 1620, resident/stored in the computer readable medium/memory 1625, one or more hardware modules coupled to the processor 1620, or some combination thereof.

In some aspects, the processing system 1610 may be a component of the network node 110 and may include one or more memories, such as the memory 242, and/or may include one or more processors, such as at least one of the TX MIMO processor 216, the RX processor 238, and/or the controller/processor 240. In some aspects, the apparatus 1605 for wireless communication includes means for sending an SR configuration associated with a trigger event for activating the SR configuration and/or means for obtaining an SR in a PUCCH occasion associated with the SR configuration. Additionally, or alternatively, the apparatus 1605 for wireless communication includes means for sending an SR configuration associated with a single-bit PUCCH format and a multi-bit PUCCH format and/or means for obtaining an SR associated with a PUCCH format selected from the single-bit PUCCH format and the multi-bit PUCCH format. The aforementioned means may be one or more of the aforementioned components of the apparatus 1500 and/or the processing system 1610 of the apparatus 1605 configured to perform the functions recited by the aforementioned means. As described elsewhere herein, the processing system 1610 may include the TX MIMO processor 216, the receive processor 238, and/or the controller/processor 240.

In one configuration, the aforementioned means may be the TX MIMO processor 216, the receive processor 238, and/or the controller/processor 240 configured to perform the functions and/or operations recited herein.

FIG. 16 is provided as an example. Other examples may differ from what is described in connection with FIG. 16.

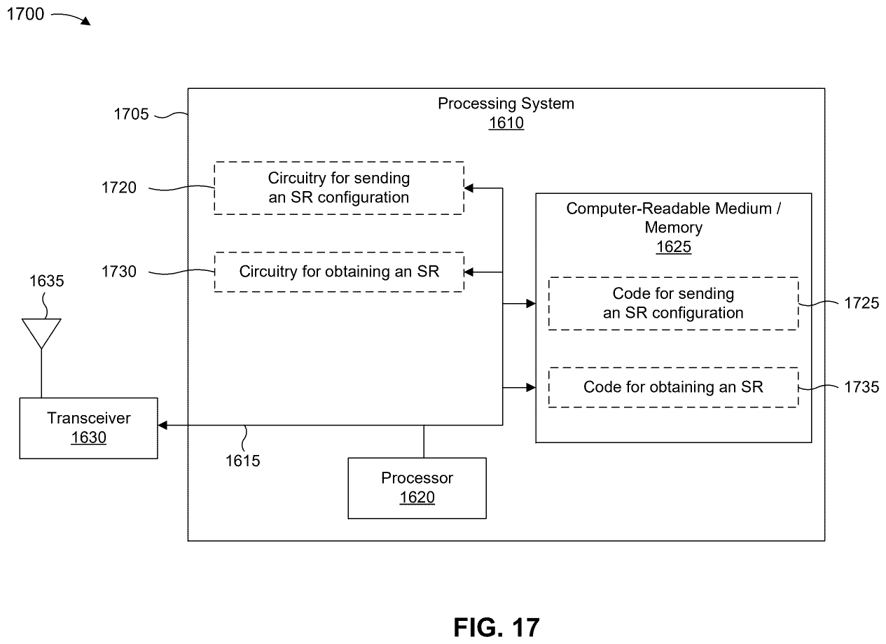

FIG. 17 is a diagram illustrating an example 1700 of an implementation of code and circuitry for an apparatus 1705, in accordance with the present disclosure. The apparatus 1705 may be a network node, or a network node may include the apparatus 1705.

As shown in FIG. 17, the apparatus 1705 may include circuitry for sending an SR configuration associated with a trigger event for activating the SR configuration (circuitry 1720). For example, the circuitry 1720 may enable the apparatus 1705 to send an SR configuration associated with a trigger event for activating the SR configuration. Additionally, or alternatively, the circuitry 1720 may enable the apparatus 1705 to send an SR configuration associated with a single-bit PUCCH format and a multi-bit PUCCH format.

As shown in FIG. 17, the apparatus 1705 may include, stored in computer-readable medium 1625, code for sending an SR configuration associated with a trigger event for activating the SR configuration (code 1725). For example, the code 1725, when executed by processor 1620, may cause processor 1620 to cause transceiver 1630 to send an SR configuration associated with a trigger event for activating the SR configuration. Additionally, or alternatively, the code 1725, when executed by processor 1620, may cause processor 1620 to cause transceiver 1630 to send an SR configuration associated with a single-bit PUCCH format and a multi-bit PUCCH format.

As shown in FIG. 17, the apparatus 1705 may include circuitry for obtaining an SR in a PUCCH occasion associated with the SR configuration (circuitry 1730). For example, the circuitry 1730 may enable the apparatus 1705 to obtain an SR in a PUCCH occasion associated with the SR configuration. Additionally, or alternatively, the circuitry 1730 may enable the apparatus 1705 to obtain an SR associated with a PUCCH format selected from the single-bit PUCCH format and the multi-bit PUCCH format.

As shown in FIG. 17, the apparatus 1705 may include, stored in computer-readable medium 1625, code for obtaining an SR in a PUCCH occasion associated with the SR configuration (code 1735). For example, the code 1735, when executed by processor 1620, may cause processor 1620 to cause transceiver 1630 to obtain an SR in a PUCCH occasion associated with the SR configuration. Additionally, or alternatively, the code 1735, when executed by processor 1620, may cause processor 1620 to cause transceiver 1630 to obtain an SR associated with a PUCCH format selected from the single-bit PUCCH format and the multi-bit PUCCH format.

FIG. 17 is provided as an example. Other examples may differ from what is described in connection with FIG. 17.

The following provides an overview of some Aspects of the present disclosure:

Aspect 1: A method of wireless communication performed at a UE, comprising: receiving an SR configuration; activating the SR configuration in accordance with a trigger event; transmitting an SR in a PUCCH occasion associated with the SR configuration; and monitoring a PDCCH search space for a PDCCH that carries an uplink grant associated with the SR.

Aspect 2: The method of Aspect 1, wherein the SR configuration is associated with the PDCCH search space.

Aspect 3: The method of Aspect 2, wherein activating the SR configuration in accordance with the trigger event comprises: activating the SR configuration based at least in part on the PDCCH search space associated with the SR configuration being a monitored PDCCH search space.

Aspect 4: The method of Aspect 2, wherein activating the SR configuration in accordance with the trigger event comprises: deactivating one or more SR configurations that are associated with other PDCCH search spaces based at least in part on the PDCCH search space associated with the SR configuration being a monitored PDCCH search space.

Aspect 5: The method of any of Aspects 1-4, further comprising: receiving a configuration designating the SR configuration to be used in an unsynchronized state; and activating the SR configuration in accordance with a condition associated with the unsynchronized state being satisfied.

Aspect 6: The method of any of Aspects 1-5, wherein activating the SR configuration in accordance with the trigger event comprises: starting a timer in response to receiving scheduling DCI for an uplink data transmission; and activating the SR configuration in accordance with the timer expiring without receiving another scheduling DCI.

Aspect 7: The method of any of Aspects 1-6, further comprising: deactivating the SR configuration during a DRX inactive time in accordance with the SR configuration having a priority that satisfies a threshold.

Aspect 8: The method of any of Aspects 1-7, wherein activating the SR configuration in accordance with the trigger event comprises: activating the SR configuration during a DRX on duration in accordance with the SR configuration having a priority that satisfies a threshold.

Aspect 9: The method of any of Aspects 1-8, further comprising: receiving a wakeup signal during a DRX inactive time; and activating the SR configuration in accordance with receiving the wakeup signal.

Aspect 10: The method of any of Aspects 1-9, further comprising: receiving one or more RRC messages configuring a set of candidate SR configurations; receiving an indication to activate one or more candidate SR configurations, from the set of candidate SR configurations; and activating the SR configuration in accordance with the SR configuration being among the one or more candidate SR configurations associated with the indication.

Aspect 11: The method of any of Aspects 1-10, further comprising: receiving one or more RRC messages configuring a set of candidate SR configurations; receiving an indication to deactivate one or more candidate SR configurations, from the set of candidate SR configurations; and deactivating the SR configuration in accordance with the SR configuration being among the one or more candidate SR configurations associated with the indication.

Aspect 12: The method of any of Aspects 1-11, further comprising: obtaining a prediction that uplink data will arrive in an uplink buffer; and transmitting predictive information to activate the SR configuration before the uplink data arrives in the uplink buffer.

Aspect 13: The method of Aspect 12, wherein the prediction is associated with an AI/ML model.

Aspect 14: The method of Aspect 12, wherein the predictive information is transmitted based at least in part on the uplink data predicted to arrive in the uplink buffer having a size that satisfies a threshold.

Aspect 15: The method of Aspect 12, wherein the predictive information includes a predictive buffer status report indicating an index of a logical channel group associated with the uplink data predicted to arrive in the uplink buffer, a size of the uplink data predicted to arrive in the uplink buffer, a number of transmission time intervals until the uplink data is predicted to arrive in the uplink buffer, or a combination thereof.

Aspect 16: The method of Aspect 12, wherein the predictive information includes a predictive SR based at least in part on the uplink data predicted to arrive in the uplink buffer having an unknown size.

Aspect 17: The method of Aspect 12, wherein the predictive information includes a predictive SR indicating an index of a logical channel group associated with the uplink data predicted to arrive in the uplink buffer, a number of transmission time intervals until the uplink data is predicted to arrive in the uplink buffer, or a combination thereof.

Aspect 18: The method of Aspect 12, further comprising: receiving information configuring one or more conditions for reporting the predictive information, wherein the predictive information is transmitted based at least in part on the one or more conditions being satisfied.

Aspect 19: The method of Aspect 18, wherein the one or more conditions include high-priority SR resources being deactivated, a predicted arrival time of the uplink data being less than or equal to a first threshold, a predicted arrival time of the uplink data being greater than or equal to a second threshold, no predictive information having been transmitted within a threshold duration, or a combination thereof.

Aspect 20: The method of any of Aspects 1-19, further comprising: receiving, in a PDCCH occasion associated with the monitored PDCCH search space, the PDCCH that carries the uplink grant associated with the SR; and transmitting uplink data in a PUSCH resource indicated in the uplink grant.

Aspect 21: A method of wireless communication performed at a UE, comprising: receiving an SR configuration associated with a single-bit PUCCH format and a multi-bit PUCCH format; transmitting an SR associated with a PUCCH format selected from the single-bit PUCCH format and the multi-bit PUCCH format; and monitoring a PDCCH search space for a PDCCH that carries an uplink grant associated with the SR.

Aspect 22: The method of Aspect 21, wherein the SR includes one bit to request the uplink grant and one or more bits to indicate a priority associated with the request in accordance with the selected PUCCH format being the multi-bit PUCCH format.

Aspect 23: The method of any of Aspects 21-22, wherein the SR includes one or more bits to indicate a trigger associated with the SR in accordance with the selected PUCCH format being the multi-bit PUCCH format.

Aspect 24: The method of any of Aspects 21-23, wherein the selected PUCCH format is the single-bit PUCCH format in accordance with the SR having a priority that satisfies a threshold.

Aspect 25: The method of any of Aspects 21-24, wherein the SR is transmitted in a PUCCH occasion associated with the selected PUCCH format.

Aspect 26: The method of any of Aspects 21-25, wherein the selected PUCCH format is the multi-bit PUCCH format in accordance with the SR being transmitted in a PUCCH occasion associated with the single-bit PUCCH format and the multi-bit PUCCH format.

Aspect 27: A method of wireless communication performed at a network node, comprising: sending an SR configuration associated with a trigger event for activating the SR configuration; and obtaining an SR in a PUCCH occasion associated with the SR configuration.

Aspect 28: The method of Aspect 27, wherein the SR configuration is associated with a PDCCH search space.

Aspect 29: The method of any of Aspects 27-28, further comprising: sending a configuration designating the SR configuration associated to be used in an unsynchronized state.

Aspect 30: The method of any of Aspects 27-29, further comprising: sending information configuring a timer to be started when scheduling DCI for an uplink data transmission is received; and sending an indication to activate the SR configuration when the timer expires.

Aspect 31: The method of any of Aspects 27-30, wherein the SR configuration is deactivated during a DRX inactive time in accordance with the SR configuration having a priority that satisfies a threshold.

Aspect 32: The method of any of Aspects 27-31, wherein the SR configuration is activated during a DRX on duration in accordance with the SR configuration having a priority that satisfies a threshold.

Aspect 33: The method of any of Aspects 27-32, further comprising: sending a wakeup signal during a DRX inactive time, wherein the wakeup signal activates the SR configuration.

Aspect 34: The method of any of Aspects 27-33, further comprising: sending one or more RRC messages configuring a set of candidate SR configurations; and sending an indication to activate one or more candidate SR configurations, from the set of candidate SR configurations.

Aspect 35: The method of any of Aspects 27-34, further comprising: sending one or more RRC messages configuring a set of candidate SR configurations; and sending an indication to deactivate one or more candidate SR configurations, from the set of candidate SR configurations.

Aspect 36: The method of any of Aspects 27-35, further comprising: obtaining predictive information to activate the SR configuration before uplink data arrives in an uplink buffer.

Aspect 37: The method of Aspect 36, wherein the predictive information is associated with an AI/ML model.

Aspect 38: The method of Aspect 36, wherein the predictive information includes a predictive buffer status report indicating an index of a logical channel group associated with the uplink data predicted to arrive in the uplink buffer, a size of the uplink data predicted to arrive in the uplink buffer, a number of transmission time intervals until the uplink data is predicted to arrive in the uplink buffer, or a combination thereof.

Aspect 39: The method of Aspect 36, wherein the predictive information includes a predictive SR indicating an index of a logical channel group associated with the uplink data predicted to arrive in the uplink buffer, a number of transmission time intervals until the uplink data is predicted to arrive in the uplink buffer, or a combination thereof.

Aspect 40: The method of Aspect 36, further comprising: sending information configuring one or more conditions for reporting the predictive information, wherein the predictive information is transmitted based at least in part on the one or more conditions being satisfied.

Aspect 41: The method of Aspect 40, wherein the one or more conditions include high-priority SR resources being deactivated, a predicted arrival time of the uplink data being less than or equal to a first threshold, a predicted arrival time of the uplink data being greater than or equal to a second threshold, no predictive information having been transmitted within a threshold duration, or a combination thereof.

Aspect 42: The method of any of Aspects 27-41, further comprising: sending, in a PDCCH occasion, a PDCCH that carries an uplink grant associated with the SR; and obtaining uplink data in a PUSCH resource indicated in the uplink grant.

Aspect 43: A method of wireless communication performed at a network node, comprising: sending an SR configuration associated with a single-bit PUCCH format and a multi-bit PUCCH format; and obtaining an SR associated with a PUCCH format selected from the single-bit PUCCH format and the multi-bit PUCCH format.

Aspect 44: The method of Aspect 43, wherein the SR includes one bit to request an uplink grant and one or more bits to indicate a priority associated with the request in accordance with the selected PUCCH format being the multi-bit PUCCH format.

Aspect 45: The method of any of Aspects 43-44, wherein the SR includes one or more bits to indicate a trigger associated with the SR in accordance with the selected PUCCH format being the multi-bit PUCCH format.

Aspect 46: The method of any of Aspects 43-45, wherein the selected PUCCH format is the single-bit PUCCH format in accordance with the SR having a high priority.

Aspect 47: The method of any of Aspects 43-46, wherein the SR is transmitted in a PUCCH occasion associated with the selected PUCCH format.

Aspect 48: The method of any of Aspects 43-47, wherein the selected PUCCH format is the multi-bit PUCCH format in accordance with the SR being transmitted in a PUCCH occasion associated with the single-bit PUCCH format and the multi-bit PUCCH format.

Aspect 49: A method of wireless communication performed at a UE, comprising: receiving an SR configuration; and deactivating the SR configuration in accordance with a trigger event.

Aspect 50: A method of wireless communication performed at a network node, comprising: sending an SR configuration associated with a trigger event for deactivating the SR configuration.

Aspect 51: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-50.

Aspect 52: An apparatus for wireless communication at a device, the apparatus comprising one or more memories and one or more processors coupled to the one or more memories, the one or more processors configured to cause the device to perform the method of one or more of Aspects 1-50.

Aspect 53: An apparatus for wireless communication, the apparatus comprising at least one means for performing the method of one or more of Aspects 1-50.

Aspect 54: A non-transitory computer-readable medium storing code for wireless communication, the code comprising instructions executable by one or more processors to perform the method of one or more of Aspects 1-50.

Aspect 55: A non-transitory computer-readable medium storing a set of instructions for wireless communication, the set of instructions comprising one or more instructions that, when executed by one or more processors of a device, cause the device to perform the method of one or more of Aspects 1-50.

Aspect 56: A device for wireless communication, the device comprising a processing system that includes one or more processors and one or more memories coupled with the one or more processors, the processing system configured to cause the device to perform the method of one or more of Aspects 1-50.

Aspect 57: An apparatus for wireless communication at a device, the apparatus comprising one or more memories and one or more processors coupled to the one or more memories, the one or more processors individually or collectively configured to cause the device to perform the method of one or more of Aspects 1-50.

Aspect 58: An apparatus for wireless communication at a device, comprising: a processing system that includes processor circuitry and memory circuitry that stores code and is coupled with the processor circuitry, the processing system configured to cause the device to perform the method of one or more of Aspects 1-50.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors coupled with the one or more memories and configured to cause the UE to:
receive a scheduling request (SR) configuration;
activate the SR configuration in accordance with a trigger event;
transmit an SR in a physical uplink control channel (PUCCH) occasion associated with the SR configuration; and
monitor a physical downlink control channel (PDCCH) search space for a PDCCH that carries an uplink grant associated with the SR.

2. The apparatus of claim 1, wherein the SR configuration is associated with the PDCCH search space.

3. The apparatus of claim 2, wherein to activate the SR configuration in accordance with the trigger event, the one or more processors are configured to cause the UE to:
activate the SR configuration based at least in part on a determination that the PDCCH search space associated with the SR configuration is a monitored PDCCH search space; and
deactivate one or more SR configurations associated with other PDCCH search spaces based at least in part on the determination that the PDCCH search space associated with the SR configuration is the monitored PDCCH search space.

4. The apparatus of claim 1, wherein to activate the SR configuration in accordance with the trigger event, the one or more processors are configured to cause the UE to:
start a timer in response to receipt of scheduling downlink control information (DCI) for an uplink data transmission; and
activate the SR configuration in accordance with expiration of the timer without receipt of another scheduling DCI.

5. The apparatus of claim 1, wherein the one or more processors are configured to cause the UE to:
deactivate the SR configuration during a discontinuous reception (DRX) inactive time in accordance with a priority of the SR configuration that satisfies a threshold.

6. The apparatus of claim 1, wherein to activate the SR configuration in accordance with the trigger event, the one or more processors are configured to cause the UE to:
activate the SR configuration during a discontinuous reception (DRX) on duration in accordance with a priority of the SR configuration that satisfies a threshold or during a DRX inactive time in accordance with receipt of a wakeup signal during the DRX inactive time.

7. The apparatus of claim 1, wherein the one or more processors are configured to cause the UE to:
receive one or more radio resource control (RRC) messages that configure a set of candidate SR configurations;
receive an indication of an activation status or a deactivation status for one or more candidate SR configurations, from the set of candidate SR configurations; and
apply the activation status or the deactivation status to the SR configuration in accordance with a determination that the SR configuration is among the one or more candidate SR configurations associated with the indication.

8. The apparatus of claim 1, wherein the one or more processors are configured to cause the UE to:
obtain a prediction that uplink data will arrive in an uplink buffer; and
transmit predictive information to activate the SR configuration before the uplink data arrives in the uplink buffer.

9. The apparatus of claim 8, wherein the predictive information includes a predictive SR based at least in part on a determination that the uplink data predicted to arrive in the uplink buffer has an unknown size.

10. The apparatus of claim 8, wherein the predictive information includes a predictive SR that indicates an index of a logical channel group associated with the uplink data predicted to arrive in the uplink buffer, a number of transmission time intervals until the uplink data is predicted to arrive in the uplink buffer, or a combination thereof.

11. The apparatus of claim 8, wherein the predictive information is transmitted based at least in part on a determination that the uplink data predicted to arrive in the uplink buffer has a size that satisfies a threshold.

12. The apparatus of claim 8, wherein the predictive information includes a predictive buffer status report that indicates an index of a logical channel group associated with the uplink data predicted to arrive in the uplink buffer, a size of the uplink data predicted to arrive in the uplink buffer, a number of transmission time intervals until the uplink data is predicted to arrive in the uplink buffer, or a combination thereof.

13. The apparatus of claim 8, wherein the one or more processors are configured to cause the UE to:
receive information that configures one or more conditions to report the predictive information, wherein the predictive information is transmitted based at least in part on a determination that the one or more conditions are satisfied.

14. The apparatus of claim 1, wherein the one or more processors are further configured to cause the UE to:
receive a configuration that designates the SR configuration to be used in an unsynchronized state; and
activate the SR configuration in accordance with satisfaction of a condition associated with the unsynchronized state.

15. An apparatus for wireless communication at a user equipment (UE), comprising:
one or more memories; and
one or more processors coupled with the one or more memories and configured to cause the UE to:
receive a scheduling request (SR) configuration associated with a single-bit physical uplink control channel (PUCCH) format and a multi-bit PUCCH format;
transmit an SR associated with a PUCCH format selected from the single-bit PUCCH format and the multi-bit PUCCH format; and
monitor a physical downlink control channel (PDCCH) search space for a PDCCH that carries an uplink grant associated with the SR.

16. The apparatus of claim 15, wherein the SR includes one bit to request the uplink grant and one or more bits to indicate a priority associated with the request in accordance with a determination that the selected PUCCH format is the multi-bit PUCCH format.

17. The apparatus of claim 15, wherein the SR includes one or more bits to indicate a trigger associated with the SR in accordance with a determination that the selected PUCCH format is the multi-bit PUCCH format.

18. The apparatus of claim 15, wherein the selected PUCCH format is the single-bit PUCCH format in accordance with a priority of the SR that satisfies a threshold.

19. The apparatus of claim 15, wherein the selected PUCCH format is the multi-bit PUCCH format in accordance with transmission of the SR in a PUCCH occasion associated with the single-bit PUCCH format and the multi-bit PUCCH format.

20. An apparatus for wireless communication at a network node, comprising:
one or more memories; and
one or more processors coupled with the one or more memories and configured to cause the network node to:
send a scheduling request (SR) configuration associated with a trigger event that activates the SR configuration; and
obtain an SR in a physical uplink control channel (PUCCH) occasion associated with the SR configuration.
